(19) United States
(12) Patent Application Publication
(10) Pub. No.: US 2012/0301250 A1
(43) Pub. Date: Nov. 29, 2012

(54) PAPER BINDER

(75) Inventor: Xiao Dong Wu, Tokyo (JP)

(73) Assignee: PLUS CORPORATION, Tokyo (JP)

(21) Appl. No.: 13/575,205

(22) PCT Filed: Jan. 13, 2011
(86) PCT No.: PCT/JP2011/000146

§ 371 Date: Jul. 25, 2012

(30) Foreign Application Priority Data
Jan. 26, 2010 (JP) 2010-014860

(51) Int. Cl. B42B 5/00

(52) U.S. Cl. 412/16

(57) ABSTRACT

The purpose of the present invention is to enable multiple paper sheets to be bound without using a binding material such as staples, and to enable the binding process to be performed appropriately and easily on paper sheets that are to be browsed. The configuration is one in which the hole-punching direction and the cutting direction are toward the handle, and the hole-punched part is visible during the binding process via a window portion. Consequently, it is possible to perform the binding process appropriately and easily on paper sheets that are to be browsed. Furthermore, because the multiple sheets are bound by a strip, it is possible to bind multiple paper sheets without using a binding material.

### CROSS-REFERENCE TO RELATED APPLICATIONS

This application is based upon and claims the benefit of priority from Japanese Patent Applications No. 2010-014860, filed Jan. 26, 2010; the entire contents of all of which are incorporated herein by reference.

### FIELD

Embodiments of the present invention relate to a paper binder that is able to punch holes into multiple paper sheets and bind them together. In particular, the present invention is related to technology that binds paper sheets using ligulate strips formed by punching holes into the paper sheets, without using staples (metal pins used for staplers) used in staplers, etc. or adhesive paste.

### BACKGROUND

Generally, as a binding tool for binding multiple paper sheets, a stapler is used. A stapler is an instrument that is able to cause the front ends of a staple to penetrate paper sheets by pinching and pressing against the paper sheets, and then passing pins through the through-holes and fastening the paper sheets together.

Staplers have the advantage of allowing paper sheets to be bounded with a simple operation, but on the other hand, there are hazards as well as inconveniences when using a shredder. That is, with staplers, there is a risk that a staple may pierce the finger, etc. of the user. Moreover, the task of removing a staple from bound paper sheets is troublesome.

Moreover, there is a risk that the user may fail to see a staple that has been removed from paper sheets. Furthermore, the user may accidentally insert paper sheets bound with a staple into a shredder or an ADF (Auto Document Feeder) of a copying machine, etc. Such accidents may cause breakdowns of the shredder or ADF.

Staplers that use paste instead of staples have been proposed (e.g., Patent Document 1: Japanese Unexamined Patent Publication No. 2006-51648). However, such staplers have the problem that the refilling or replacement of paste is difficult. Moreover, it is difficult to provide a configuration by which the adhesive strength between the paper sheets bound by the paste is increased while the application of the paste can be performed smoothly.

As described above, staplers have various problems. In relation to this, paper binders that bind paper sheets without using any binding material such as a staple or paste have been proposed (e.g., Patent Document 2: Japanese Unexamined Patent Publication No. 1966-3278 and Patent Document 3: Japanese Unexamined Patent Publication No. 1981-51389). The paper-binding process of such paper binders that do not use any binding material, for example, is described below.

In this type of paper binder, first, as in a hole puncher, a punch blade is pressed against multiple paper sheets that have been layered to punch holes in these paper sheets. However, unlike with a hole puncher, in this hole-punching process, the paper binder does not completely cut away the hole-punched part from the paper sheets. Specifically, for each of the multiple paper sheets, only part of the paper sheet is cut through (refer to FIGS. 1-3 and FIGS. 6-8 of Patent Document 2). In other words, each of the paper sheets that are hole-punched by the paper binder is separated into a ligulate strip cut away from the paper sheet and the remaining base that is not cut away (the base part of the ligulate strips).

Furthermore, in this type of paper binder, before and after the hole-punching operations, incisions for receiving the ligulate strips that are cut away by the punch blade are formed (refer to FIG. 2 of Patent Document 2). These incisions are formed by a knife provided adjacent to the punch blade (refer to symbol 3 of FIG. 2). In addition, the paper binder uses a cam attached to the punch blade (refer to symbol 5 of FIG. 2) to collect the ligulate strip of each paper sheet and push them into the incisions formed by the knife.

This paper binder binds paper sheets together in the manner described above. The bound paper sheets do not involve any binding means such as a staple, and therefore, the user may put the paper sheets through a shredder as they are. Moreover, even if the user continues to use the paper binder, there is no need to refill the binding means.

In a paper binder such as that described above, paper sheets are bound using ligulate strips formed by punching holes into multiple paper sheets. That is, the binding parts of the paper sheets are punched to form ligulate strips and then folded over, and therefore, after binding, the binding parts cannot be browsed. Consequently, when binding paper, the operator of the paper binder must select a position of the paper sheets that does not include, for example, characters or other printed parts as the paper-binding part.

With regard to this point, with a conventional paper binder such as that disclosed in Patent Document 2 or Patent Document 3, it is not possible to confirm the paper-binding part during the paper-binding process. For example, as shown in FIG. 2 of Patent Document 3, the paper-binding part of paper sheets inserted into the paper binder is covered by the hole-punching member and the cover (refer to symbol 36 in the diagram), etc. of the paper binder, visual confirmation by the operator is difficult. Consequently, the operator of a conventional paper binder confirms the part where the paper-binding process is to be performed before placing the paper sheets in the hole-punching part of the paper binder, and performs the paper-binding process while guessing about the position. However, this type of operation is troublesome and difficult. Moreover, there is the risk that the paper-binding process may not be performed accurately.

Furthermore, in the paper-binding process of a conventional paper binder, there is the risk of making it difficult to browse characters, etc. shown on the paper-binding part, such as the edge part of the paper sheets. In particular, if the paper-binding process is performed on a corner part or the top or bottom edges of the paper sheets and information such as the date of printing, the number of pages, or the publisher can no longer be confirmed, this may create problems for browsing the paper sheets.

### SUMMARY OF THE INVENTION

The present invention was made in consideration of the above problems, and the object of the present invention is to provide a paper binder that is able to bind multiple paper sheets without using any binding material such as staples, and is able to appropriately and easily perform the paper-binding process on paper sheets to be browsed.

To resolve the above problems, the invention according to claim 1 is a paper binder configure to punch a hole in a plurality of layered paper sheets to cut off part of the paper sheets and form ligulate strips and form incisions near the strips and insert the strips into the incisions to bind the paper sheets. The paper binder comprises a base; a support base erected on the base; a handle; a pair of incising blades; a pair of projections; a mounting base; a pressing portion; a window portion; and a movement mechanism.

The handle is connected to the support base via a rotation shaft and that is rotatable about the rotation shaft; a pair of punch blades that protrude from the base toward the handle and punch holes. The pair of incising blades protrude from the base toward the handle and form the incision. The pair of projections are rotated together with the rotation of the handle and press against the formed strips to fold the strips toward the paper sheets. The mounting base is arranged between the base and the handle, provided with through-holes through which the edge parts toward the projection direction of the projections, the punch blades, and the incising blades are able to pass. The paper sheets are mounted on the mounting base. The pressing portion is arranged at a position enclosed by the handle and the mounting base and is capable of receiving each of the edge parts passing through the through-holes. The pressing portion includes reception holes in the interior in which the projections are able to rotate and is configured so that the vicinity of the through-holes of the mounting base are visible from the side of the handle through at least the reception holes and their surroundings. The pressing portion pinches the paper sheets together with the mounting base. The window portion is provided on the handle at a part including a region overlapping with at least the reception holes of the pressing portion. The movement mechanism brings closely the relative positions of the pressing portion and the mounting base depending on the handle rotates and moves the mounting base toward the base together with the pressing portion.

As a result of the pressing portion and the mounting base being brought closely by the movement mechanism, the paper sheets on the mounting base are pinched, and by moving the pressing portion and the mounting base toward the base while pinching the paper sheets, the edge parts of the punch blades and the incising blades are pressed against the paper sheets to form the strips and the incision.

To resolve the above problems, the invention according to claim 4 is a paper binder comprises: a punch blade; an incising blade; a base; a mounting base; an insertion part; a rotation mechanism; an insertion part; a pressing table; a support base; and a handle.

The punch blade forms partially connected strips by punching a hole into paper sheets. The incising blade forms incisions into which the strips can be inserted. The base supports both the punch blade and the incising blade so as to cause them to protrude upward, and also supports the punch blade in a rotatable manner. The mounting base includes: a mounting surface that is arranged above the base and is approximately perpendicular to the punch blade and the incising blade; and through-holes provided on the mounting surface through which the front ends of the punch blade and the incising blade are able to pass. The rotation mechanism is provided on the mounting surface on the side of the base, and abuts the punch blade as the mounting surface and the base of the punch blade are brought closely, and causes the punch blade to rotate. The insertion part is provided on the punch blade and presses the strips into the incisions when the punch blade rotates. The pressing table includes a pressing surface and reception holes. The pressing surface is provided above the mounting surface at a position approximately facing the mounting surface. The reception holes are provided on the pressing surface on extensions of the projection directions of the punch blade and the incising blade at positions corresponding to the through-holes, and receive the front ends of the punch blade and the incising blade that pass through the through-holes. The pressing table is formed so that paper sheets on the mounting surface are visible from above in at least one region including the reception holes, and is able to move toward the mounting surface. The support base extends from the base to a position higher than at least the mounting surface. The handle is rotatably supported by the support base, and is arranged so as to enclose the pressing table and the mounting base together with the base, and is provided with a window portion that makes at least part of the pressing table including the reception holes visible from above.

As a result of the lowering of the pressing table as the handle rotates, the pressing table and the mounting base pinch the paper sheets, and as a result of the lowering of the pressing table and the mounting base associated with additional rotation of the handle, the punch blade and the incising blade form the strips and the incisions in the pinched paper sheets.

In the paper binders according to claim 1 and claim 4 described above, the hole-punching direction and the cutting direction are toward the handle side, and they are configured so that the hole-punched parts in the paper-binding process are visible via the window portion. Consequently, it is possible to appropriately and easily perform the paper-binding process on paper sheets to be browsed. Furthermore, according to the paper binder of claim 1 and claim 4 described above, because multiple paper sheets are bound by the strips, it is possible to bind multiple paper sheets without using any binding material.

### BRIEF DESCRIPTION OF THE DRAWINGS

FIG. 1A is a schematic perspective view of the outer shape of the paper binder according to the embodiment from the side of the insertion slot for paper sheets.

FIG. 1B is a schematic perspective view of the paper binder of FIG. 1A from the opposite side.

FIG. 2 is a schematic exploded perspective view showing the configuration of each part and the connections between each part of the paper binder according to the embodiment.

FIG. 3A is a schematic top view showing an overview of the paper binder according to the embodiment before the handle is pressed down.

FIG. 3B is a schematic top view showing the paper binder according to the embodiment when the handle is pressed down.

FIG. 4A is a schematic cross-sectional diagram showing an overview of the cross-section of the part A-A in FIG. 3A.

FIG. 4B is a schematic cross-sectional diagram showing the cross-section of the part A′-A′ in FIG. 3B when the handle of the paper binder has been pressed down.

FIG. 5A is a schematic top view of the outer shape of the paper binder and an overview of the internal structure of the paper binder before the rotation of the handle according to the embodiment.

FIG. 5B is a schematic top view of the outer shape of the paper binder and an overview of the internal structure of the paper binder after the rotation of the handle according to the embodiment.

FIG. 6A is a schematic cross-sectional diagram showing the cross-section of the part B-B in FIG. 5A, showing the state of the hole-punching part and the incision-forming part before the rotation of the handle.

FIG. 6B is a schematic cross-sectional diagram showing the cross-section of the part B′-B′ in FIG. 5B, showing the state of the hole-punching part and the incision-forming part after the rotation of the handle.

FIG. 6C is a schematic cross-sectional diagram showing the cross-section of the part C-C in FIG. 5A, showing the state of the hole-punching part and the incision-forming part before the rotation of the handle.

FIG. 6D is a schematic cross-sectional diagram showing the cross-section of the part C′-C′ in FIG. 5B, showing the state of the hole-punching part and the incision-forming part.

FIG. 7 is a schematic perspective view of the paper binder according to the embodiment, showing the positional relationships of the pressing portion, the mounting base, and the anterior base before the rotation of the handle.

FIG. 8A is a schematic right lateral diagram of the paper binder according to the embodiment, showing the positional relationships of the pressing portion, the mounting base, and the anterior base before the rotation of the handle.

FIG. 8B is a schematic top view of the paper binder according to the embodiment, showing the positional relationships of the pressing portion, the mounting base, and the anterior base before the rotation of the handle.

FIG. 9 is a cross-sectional diagram of the paper binder according to the embodiment along the line D-D of FIG. 8B, showing an overview of the positional relationships of the pressing portion, the mounting base, and the anterior base before the rotation of the handle.

FIG. 10 is a cross-sectional diagram of the paper binder according to the embodiment along the line E-E of FIG. 8B, showing an overview of the positional relationships of the pressing portion, the mounting base, and the anterior base before the rotation of the handle.

FIG. 11 is a schematic diagram showing a state in which the corners of paper sheets have been bound by the paper binder according to the embodiment.

FIG. 12 is a schematic perspective view of the paper binder according to the embodiment, showing the positional relationships of the pressing portion, the mounting base, and the anterior base after the rotation of the handle.

FIG. 13A is a schematic right lateral view of the paper binder according to the embodiment, showing the positional relationships of the pressing portion, the mounting base, and the anterior base after the rotation of the handle.

FIG. 13B is a schematic top view of the paper binder according to the embodiment, showing the positional relationships of the pressing portion, the mounting base, and the anterior base after the rotation of the handle.

FIG. 14 is a cross-sectional diagram of the paper binder according to the embodiment along the line D′-D′ of FIG. 13B, showing an overview of the positional relationships of the pressing portion, the mounting base, and the anterior base after the rotation of the handle.

FIG. 15 is a cross-sectional diagram of the paper binder according to the embodiment along the line E′-E′ of FIG. 13B, showing an overview of the positional relationships of the pressing portion, the mounting base, and the anterior base after the rotation of the handle.

FIG. 16 is a schematic diagram that conceptually shows the difference in width between the incising blade of the paper binder according to the embodiment and a ligulate strip formed through hole-punching.

### DETAILED DESCRIPTION OF THE PREFERRED EMBODIMENTS

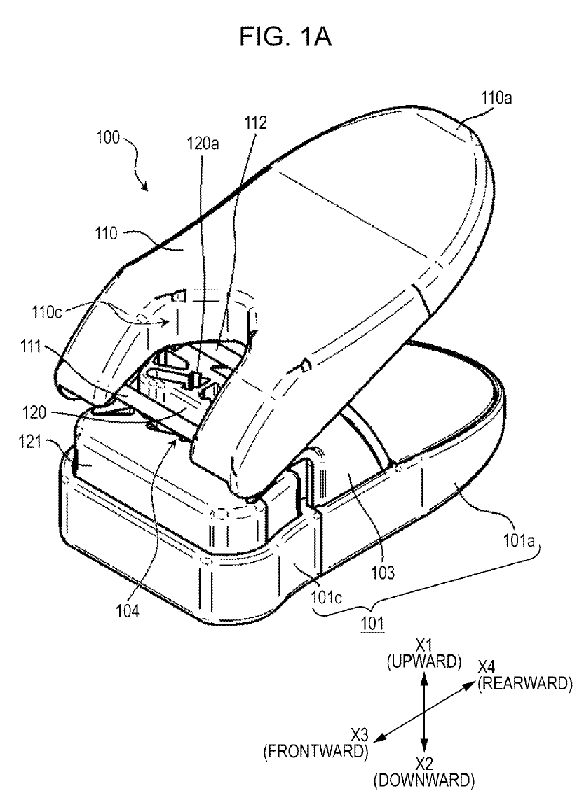

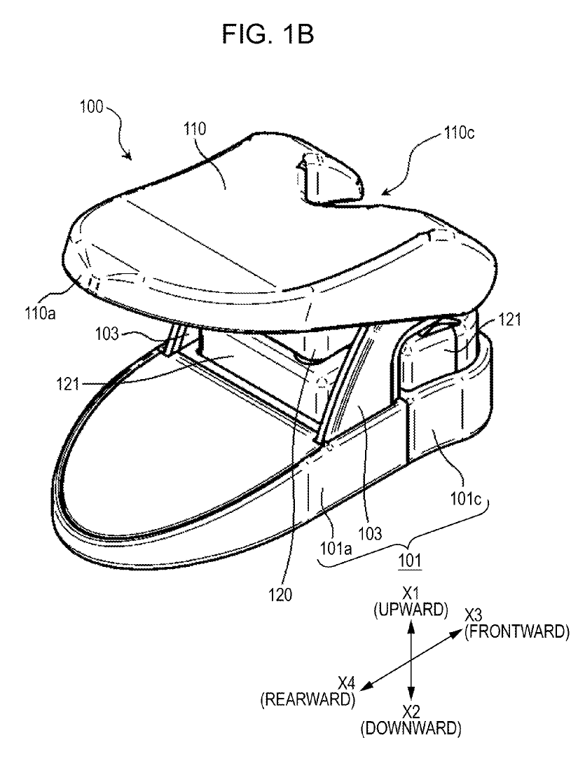

The following is a description of one example of the present embodiment, with reference to FIGS. 1A-16. To ensure the clarity of the diagrams, in these diagrams, the paper sheets being bound are omitted.

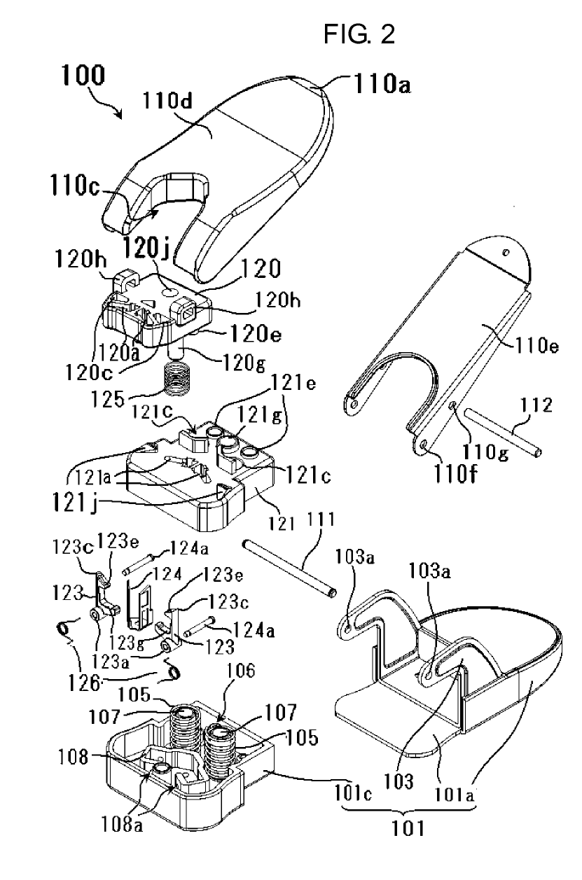

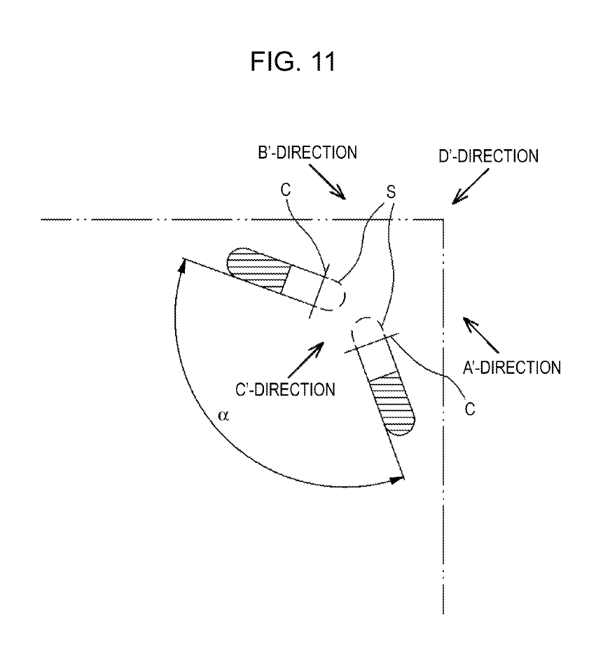

An overview of the overall configuration of a paper binder 100 according to the present embodiment is described with reference to FIG. 1A, FIG. 1B, and FIG. 2. FIG. 1A is a schematic perspective view of the outer shape of the paper binder 100 viewed from the side of the insertion slot for paper sheets. FIG. 1B is a schematic perspective view of the paper binder 100 viewed from the side opposite to FIG. 1A. FIG. 2 is a schematic exploded perspective view showing the configuration of each part and an overview of the connections between each part in the paper binder 100. The paper binder 100 punches holes in one part of paper sheets using a pair of punch blades (123c; FIG. 2) without cutting away the part from the paper sheet. As a result, first, ligulate (or square-shaped) strips (hereinafter referred to as “ligulate strips” (refer to symbol S in FIG. 11)) that remain connected to the paper sheets are formed. Moreover, in addition to punching holes, the paper binder 100 inserts incisions C (refer to FIG. 11) near each ligulate strip S using a pair of incising blades (refer to symbol 124 in FIG. 2, etc.). Then, the paper binder 100 folds over the ligulate strips S cut away from the paper sheets and presses them into the incisions using the incising blades. As a result, it is possible to bind multiple paper sheets.

An overview of the outer shape of the paper binder 100 is described. As shown in FIG. 1A and FIG. 1B, in the paper binder 100, the base formed by connecting a posterior base 101a and an anterior base 101c becomes the basis of an entire device. Moreover, on the connecting part of the posterior base 101a and the anterior base 101c, a supporting plate 103 erected in the direction away from the posterior base 101a and the anterior base 101c (i.e., a roughly upward direction) is provided. Moreover, a handle 110 is connected via a rotation shaft 111 on the end of the supporting plate 103. The handle 110 is rotatable about the rotation shaft 111 in relation to the supporting plate 103. The handle 110 is a flat plate or a plate with a curved surface. Moreover, the handle 110 is connected to the supporting plate 103 to form an acute angle relative to the base 101. Moreover, the rotation shaft 111 is arranged roughly parallel to the base 101.

In the following description, the direction from the posterior base 101a toward the anterior base 101c is defined as the forward direction (direction X3 in FIG. 1A and FIG. 1B), and the opposite direction is defined as the backward direction (X4). Furthermore, when the orientations of this forward direction and backward direction is used as a reference, the upward direction (direction X1 in FIG. 1A and FIG. 1B), the downward direction (X2), the leftward direction, and the rightward direction may be used. However, these definitions of the forward, backward, upward, downward, leftward, and rightward directions are used only for ease of explanation, and do not limit the orientation, etc. of the paper binder 100 during use.

Moreover, as shown in FIG. 1A and FIG. 1B, between the posterior base 101a and anterior base 101c on one hand and the handle 110 on the other, a pressing portion 120 and a mounting base 121 are provided in that order from the side of the handle 110. The mounting base 121 is a base for mounting paper sheets that are to be bound using the paper binder 100. The mounting base 121 is provided on the anterior base 101c. Moreover, the mounting base 121 is formed to be slightly smaller than the anterior base 101c. As described later, the mounting base 121 can be moved from the position overlapping the anterior base 101c by being guided by the anterior base 101c to engage the interior of the anterior base 101c. In other words, the upper surface of the mounting base 121 is moved upward and downward relative to the lower surface of the anterior base 101c.

Furthermore, the pressing portion 120 is provided on the mounting base 121. The pressing portion 120 is also moved upward and downward relative to the anterior base 101c by being guided by the mounting base 121. The upward and downward movement of the pressing portion 120 is performed independently of the mounting base 121 when pressing paper, and is performed together with the mounting base 121 during hole-punching.

As shown in FIG. 1A, paper sheets are inserted into the paper binder 100 from an insertion slot 104, or in other words, from the front to the back (in the direction X4 in the diagrams). The inserted paper sheets are mounted on the mounting base 121.

The following is an overview of the connections between each part. As shown in FIG. 2, in the lowermost part acting as the foundation of the entire paper binder 100, the anterior base 101c, the supporting plate 103, and the posterior base 101a are connected and combined in that order to form the base 101. On the anterior base 101c, a first cylinder portion 107 that guides the upward and downward movement of the mounting base 121, etc. is erected. Furthermore, on the first cylinder portion 107, a first elastic member 105 that adjusts the hole-punching load is provided. Furthermore, on the anterior base 101c, a holding portion 108 is provided. Specifically, on the holding portion 108, a roughly L-shaped ligulate-strip processing portion 123 and the incising blades 124 are provided with the blade parts (the punch blades 123c, etc.) facing upward. Furthermore, the ligulate-strip processing portion 123 is rotatable via a rotation shaft 124a. Moreover, on the front end of the ligulate-strip processing portion 123, a projection 123e that protrudes in the direction of rotation is provided. The projection 123e presses the ligulate strips S into an engaging hole 124c of the incising blades 124.

The mounting base 121 is arranged above the base 101 and is connected to the first cylinder portion 107 of the base 101 erected upward via a first guide hole 121c. Because the first guide hole 121c is passed through the first cylinder portion 107, the upward and downward movement of the mounting base 121 relative to the anterior base 101c is guided.

The pressing portion 120 is arranged above the mounting base 121. The pressing portion 120 has a second guide brace member 120g that extends downward. The second guide brace member 120g is passed through to the interior of the first cylinder portion 107 that has been passed through the first guide hole 121c. As a result, the pressing portion 120 is connected to the mounting base 121 and the anterior base 101c. The upward and downward movement of the pressing portion 120 relative to the mounting base 121 and the anterior base 101c is guided by the second guide brace member 120g.

The handle 110 is arranged above the pressing portion 120. The handle 110 is configured with a handle frame 110e and a handle cover 110d. The handle cover 110d is a cover for the handle frame 110e. By passing the rotation shaft 111 through the handle frame 110e, the handle 110 is rotatably connected to the supporting plate 103. Furthermore, at a position between a protruding end 110a and the rotation shaft 111, a pressure shaft 112 is passed through the handle frame 110e. The pressure shaft 112 also penetrates an engaging portion 120h of the pressing portion 120. The handle 110 and the pressing portion 120 are connected by the pressure shaft 112.

Moreover, on the mounting base 121, a through-hole 121a is provided. Moreover, on the pressing portion 120, a reception hole 120a is provided. The punch blades 123c of the ligulate-strip processing portion 123 and the incising blades 124 are passed through these holes.

The supporting plate 103 is one example of the “support base” of the present invention. Moreover, an aperture portion 110c and the pressing portion 120 are one example of the “window portion” of the present invention. Moreover, the first elastic member 105 is one example of the “biasing portion” of the present invention. Moreover, the first guide hole 121c is one example of the “penetration portion” of the present invention. Moreover, the first cylinder portion 107 is one example of the “brace member” of the present invention. Moreover, a rotation shaft through-hole 110f is an example of the “axis hole” of the present invention.

Moreover, the blade parts of the front ends of the punch blades 123c and the incising blades 124 of the ligulate-strip processing portion 123 are one example of the “erect edge parts of the punch blades and the incising blades” of the present invention. Moreover, at least the first cylinder portion 107, the second guide brace member 120g, and the first guide hole 121c are one example of the “movement mechanism” of the present invention, and furthermore, for the “movement mechanism”, at least one of a second elastic member 125 and the first elastic member 105, or a combination of both, may be included. Furthermore, for the “movement mechanism”, any one of the engaging portion 120h, a pressing portion guide 120e, a second guide hole 121e, and the pressure shaft 112, or a combination thereof, may be included.

### (Overview of Operations)

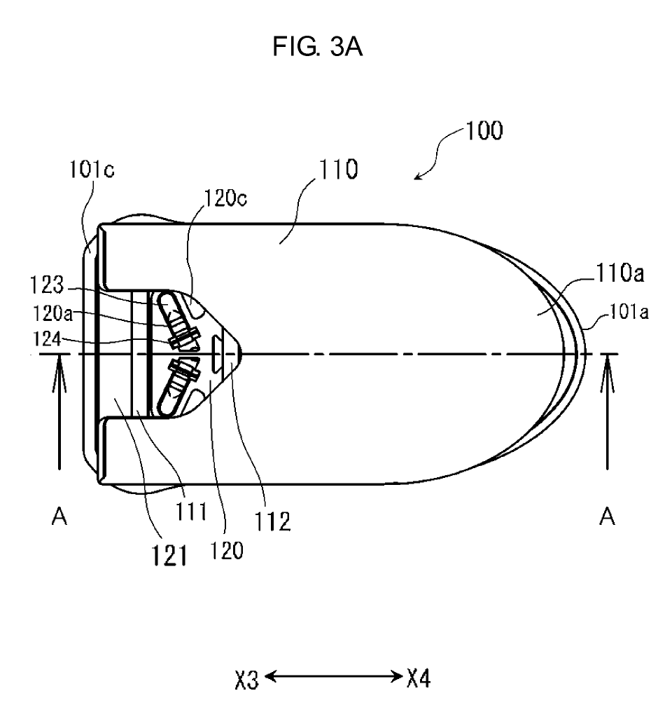

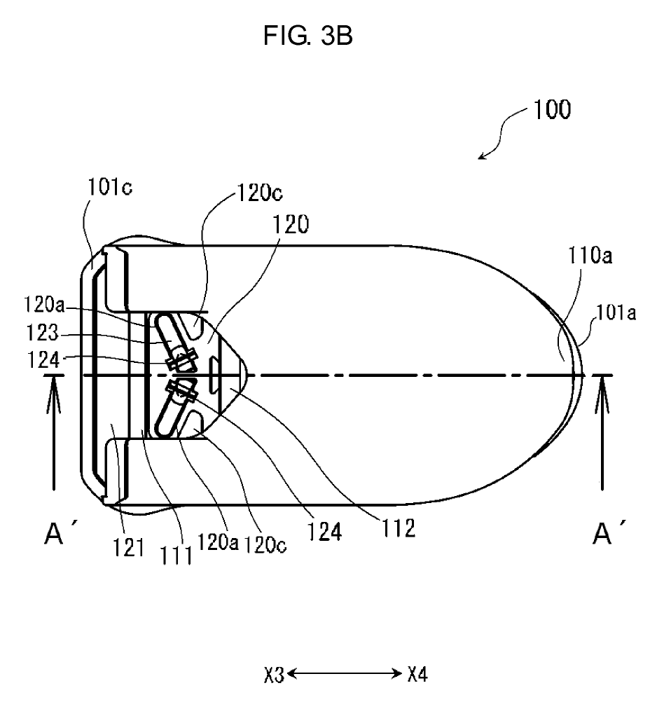

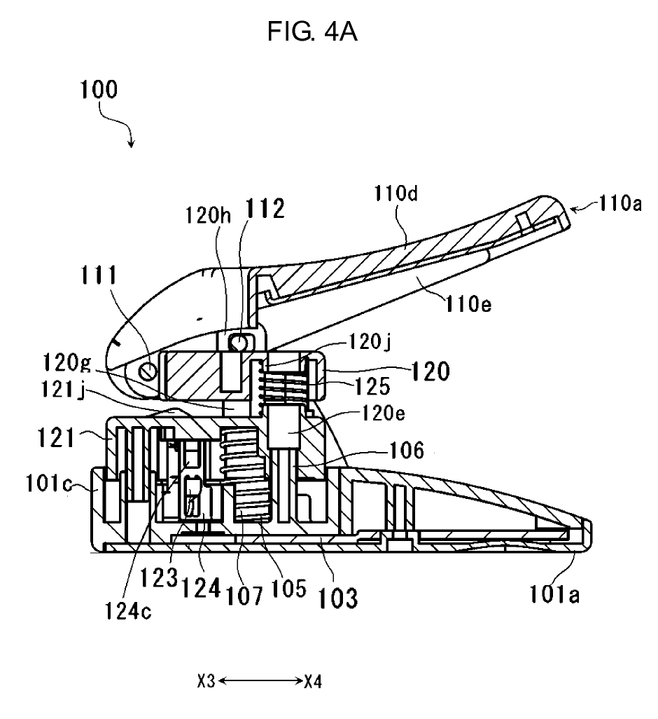

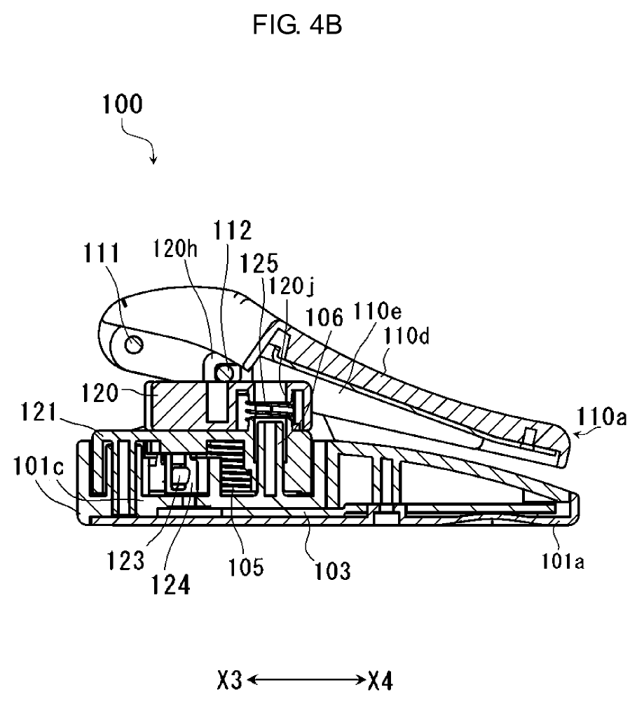

Next, an overview of operations of the paper binder 100 according to the embodiment will be described with reference to FIGS. 2-4B. FIG. 3A is a schematic top view showing an overview of the paper binder 100 before the handle 110 is pressed down. FIG. 3B is a schematic top view of the paper binder 100 when the handle 110 has been pressed down. FIG. 4A is a schematic cross-sectional diagram of the paper binder 100 along the part A-A in FIG. 3A. FIG. 4B is a schematic cross-sectional diagram of the part A′-A′ of FIG. 3B, showing an overview of the state of each part when the handle of the paper binder has been pressed down and hole-punching, the folding of the ligulate strips S, and the pressing of the ligulate strips S into the incisions C have been completed. Although this is not illustrated, in the following overview of operations, the paper sheets to be bound by the operator have already been inserted into the insertion slot 104, and the paper sheets have been mounted on the mounting base 121.

As shown in FIG. 3A and FIG. 4A, before the operator performs an operation to press down the handle 110, the pressing portion 120 positioned toward the handle 110 is positioned with a prescribed interval of space from the mounting base 121. Here, as shown in FIG. 3B and FIG. 4B, when the operator grips, for example, the protruding end 110a of the handle 110 and pressed the handle downward, the handle 110 is first rotated about the rotation shaft 111, and the lower surface of the handle 110 is pressed down toward the upper surface of the posterior base 101a and the anterior base 101c and both surfaces are brought closer.

When the handle 110 starts to be rotated, the force applied to the handle 110 first acts on the pressure shaft 112 supported by the engaging portion 120h of the pressing portion 120. As a result, via the pressure shaft 112 supported by the handle 110, the pressing portion 120 descends as the handle 110 is rotated. Here, until the handle 110 is pressed down, the pressing portion 120 is biased away from the mounting base 121 (i.e., upward) (FIG. 4A, FIG. 2; symbol 125). Consequently, when the handle 110 starts to descend, the pressing portion 120 descends against this biasing force and nears the paper sheets on the mounting base 121.

The pressing portion 120 descends and abuts the paper sheets on the mounting base 121, and when the handle 110 is rotated further, the pressing portion 120 presses down the paper sheets and the mounting base 121. Moreover, until it is pressed down via the pressing portion 120, the mounting base 121 is also biased away from the anterior base 101c (i.e., upward) (FIG. 4A, FIG. 2; symbol 105). Consequently, when the pressing portion 120 starts to press down the mounting base 121, the mounting base 121 is pressed down against this biasing force while the lower surface of the pressing portion 120 and the upper surface of the mounting base 121 pinch the paper sheets.

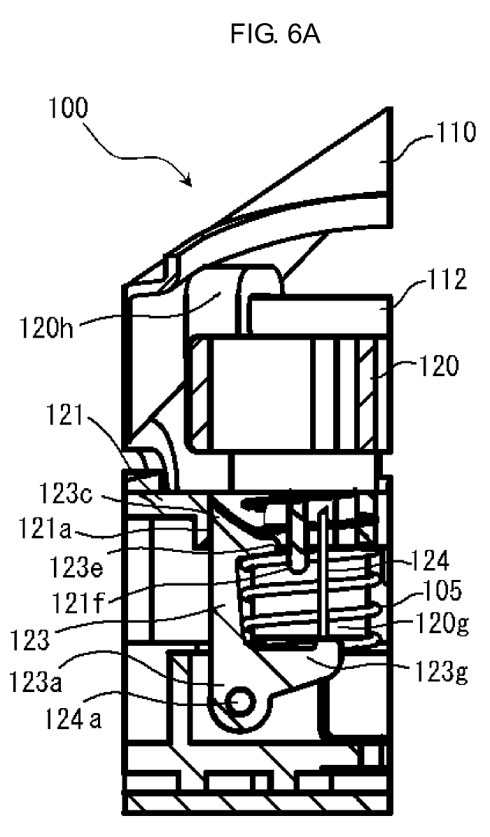

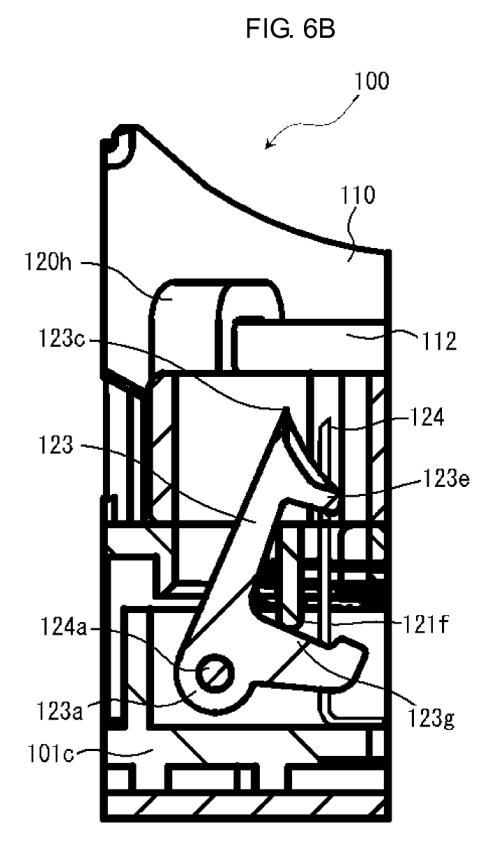

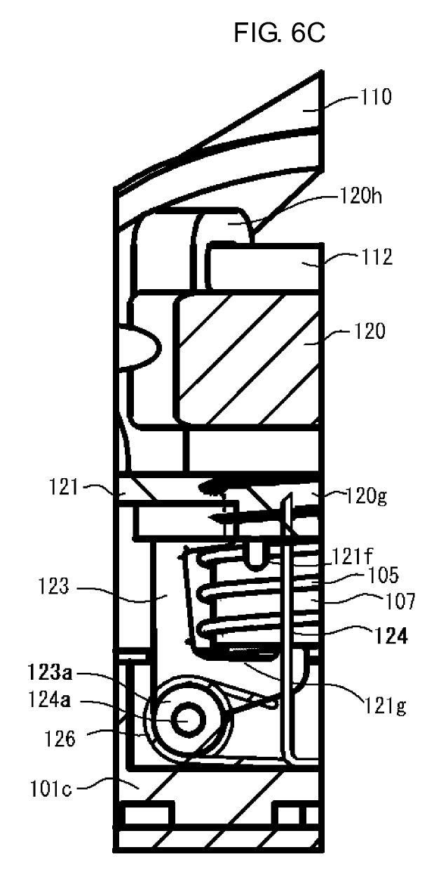

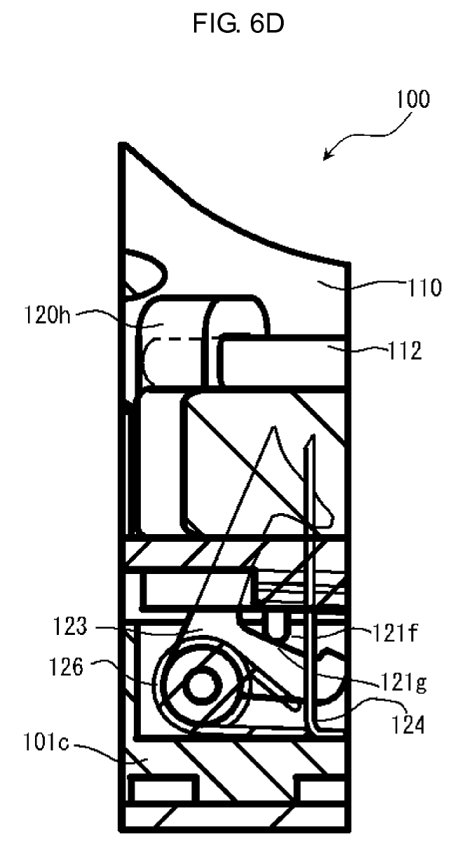

The ligulate-strip processing portion 123 and the incising blades 124 shown in FIG. 2 are each fixed to the holding portion 108 of the anterior base 101c (refer to FIG. 6A). Furthermore, the ligulate-strip processing portion 123 and the incising blades 124 are each provided with blade parts on their respective upper edge sides. When the mounting base 121 descends, the blade parts of the ligulate-strip processing portion 123 and the incising blades 124 pass through the upper surface of the mounting base 121 via the through-hole 121a. At this time, because the pressing portion 120 is holding down the paper sheets on the mounting base 121, the ligulate-strip processing portion 123 punches a hole in the paper sheets and forms the ligulate strips S, and the incising blades 124 form the incisions C in the paper sheets.

As shown in FIG. 4B, when the handle 110 is rotated to the point where the protruding end 110a comes into contact with the posterior base 101a, the ligulate-strip processing portion 123 is rotated. The projection 123e of the ligulate-strip processing portion 123 presses the ligulate strips S formed by the hole-punching into the engaging holes 124c of the incising blades 124. Moreover, by returning to the base 101, the incising blades 124 press the ligulate strips S into the incisions C. The paper binder 100 performs the paper-binding process through such a process.

### (Overall Configuration)

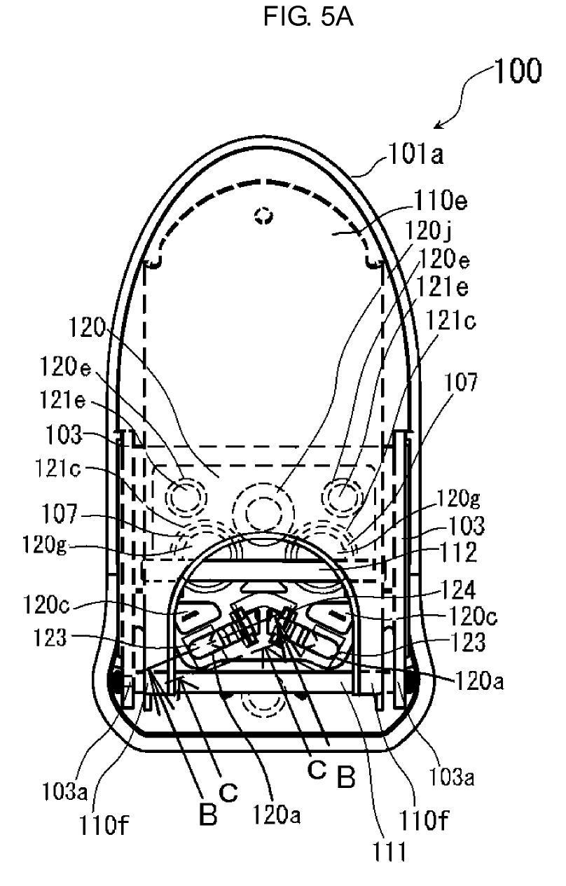

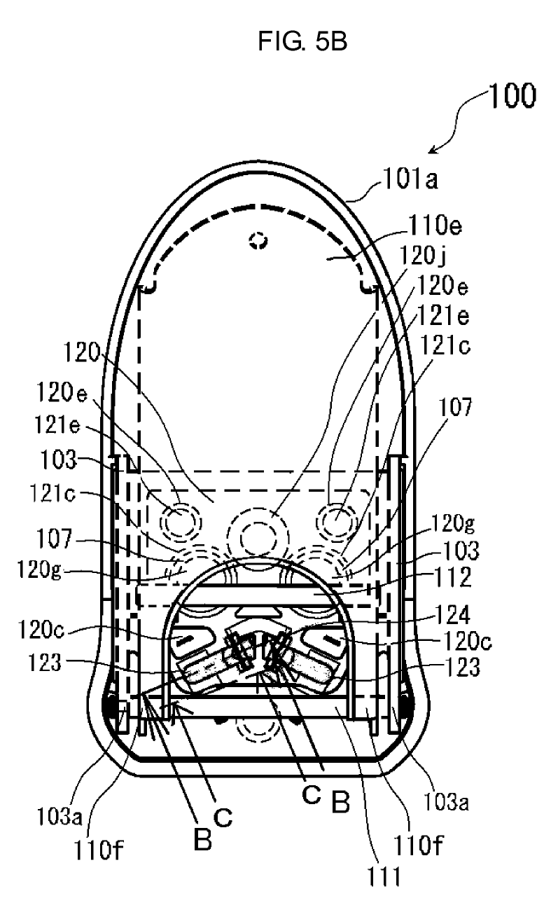

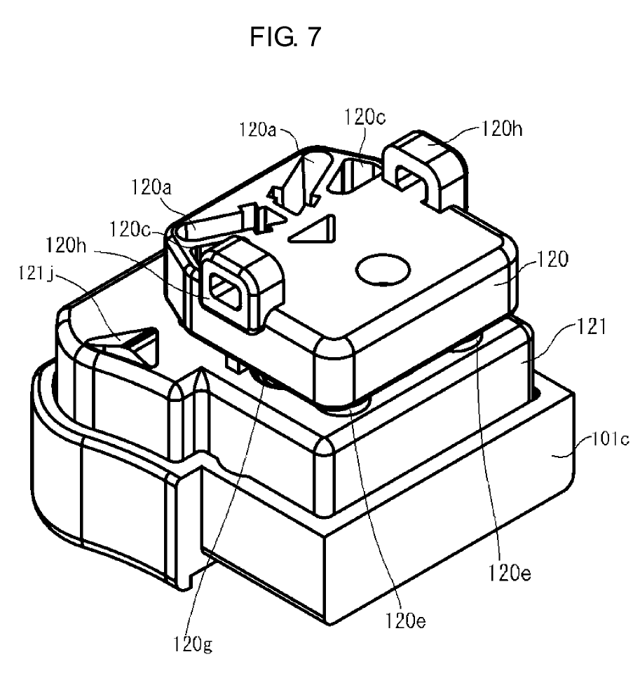

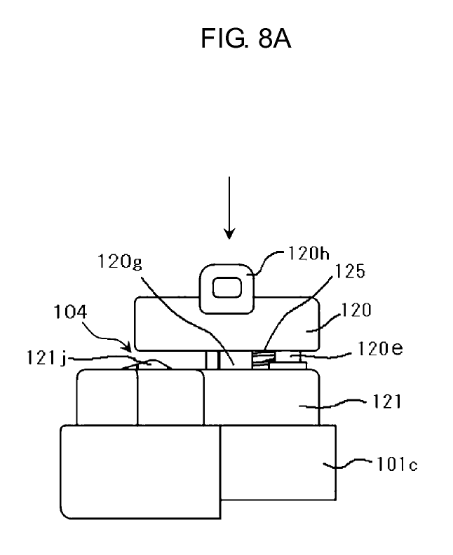

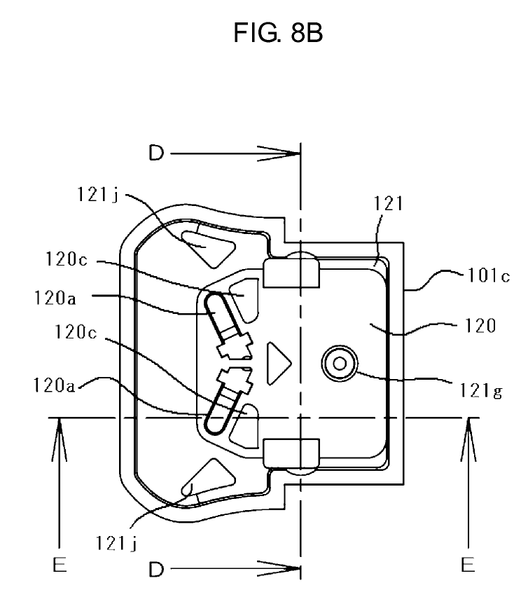

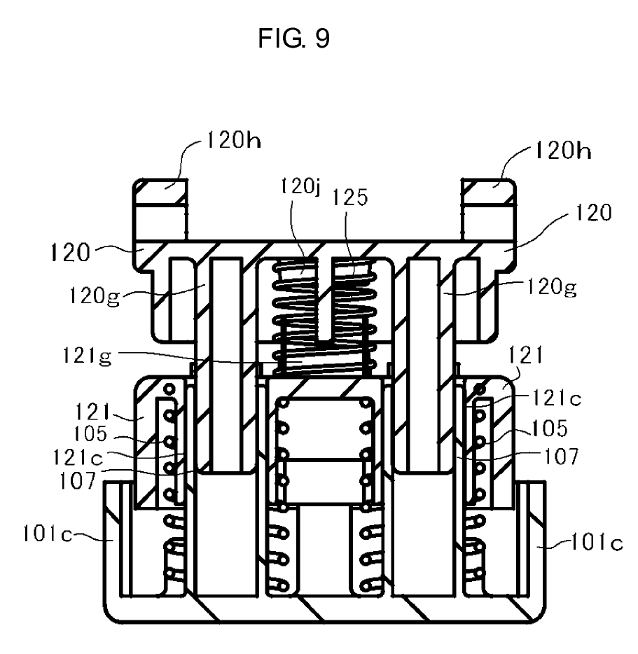

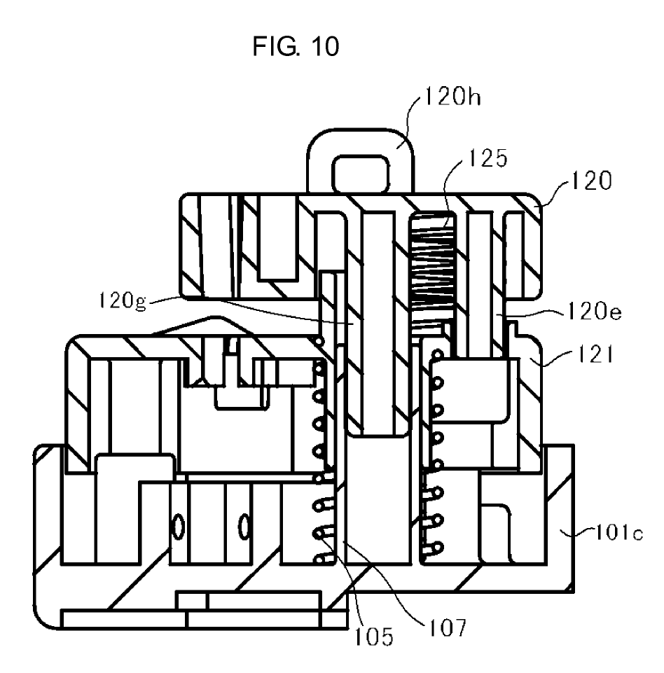

Next, the configurations of each part of the paper binder 100 according to the present embodiment will be described with reference to FIGS. 1A-10. FIG. 5A is a schematic transparent top view showing an overview of the positional relationships of each part of the paper binder 100 before the handle is rotated. In this diagram, part of the internal structures of the pressing portion 120, the mounting base 121, and the anterior base 101c, etc. are also shown through the handle cover 110d of the handle 110. FIG. 5B is a schematic transparent top view showing an overview of the positional relationships of each part of the paper binder 100 after the handle 110 has been rotated. FIG. 6A is a schematic cross-sectional diagram of the part B-B of FIG. 5A, showing the state of the hole-punching part and the incision-forming part before the handle 110 is rotated. FIG. 6B is a schematic cross-sectional diagram of the part B′-B′ of FIG. 5B, showing the state of the hole-punching part and the incision-forming part after the handle 110 has been rotated. FIG. 6C is a schematic cross-sectional diagram of the part C-C of FIG. 5A, showing the state of the hole-punching part and the incision-forming part before the handle 110 is rotated. FIG. 6D is a schematic cross-sectional diagram of the part C′-C′ of FIG. 5B, showing the state of the hole-punching part and the incision-forming part. FIG. 7 is a schematic perspective view showing the positional relationships of the pressing portion 120, the mounting base 121, and the anterior base 101c before the handle 110 is rotated. FIG. 8A is a schematic right lateral view showing the positional relationships of the pressing portion 120, the mounting base 121, and the anterior base 101c before the handle 110 is rotated. FIG. 8B is a schematic top view showing the positional relationships of the pressing portion 120, the mounting base 121, and the anterior base 101c before the handle 110 is rotated. FIG. 9 is a cross-sectional diagram of the part D-D of FIG. 8B, showing an overview of the positional relationships of the pressing portion 120, the mounting base 121, and the anterior base 101c before the handle 110 is rotated. FIG. 10 is a cross-sectional diagram of the part E-E of FIG. 8B, showing an overview of the positional relationships of the pressing portion 120, the mounting base 121, and the anterior base 101c before the handle 110 is rotated.

(Base 101)

As described above, the configurations forming the base in the paper binder 100 are the posterior base 101a, the anterior base 101c, and the supporting plate 103. As shown in FIG. 1A, FIG. 1B, and FIG. 2, the rearward edge part of the posterior base 101a is curved. The frontward side of the posterior base 101a is formed so as to receive the supporting plate 103 and the anterior base 101c. As shown in FIG. 2, the supporting plate 103 is arranged on the frontward (X3 direction) side of the posterior base 101a. Furthermore, the anterior base 101c is fitted and fixed to the posterior base 101a on which the supporting plate 103 is provided.

As shown in FIG. 2, the supporting plate 103 includes a pair of side plates that are flat plates erected from the rightward and leftward surfaces of the base 101, as well as a bottom plate part that links these side plates. The side plates are erected upward. The front edge parts of the side plates have a roughly reverse L-shape that is curved toward the front. Moreover, the front edge parts of the side plates of the supporting plate 103 are connected to the handle 110 via the rotation shaft 111. Due to this connection with the rotation shaft 111, the front edge parts of the side plates are provided with bearings 103a. The bearings 103a support both edge parts in the axial direction of the rotation shaft 111. The rotation shaft 111 is supported to be roughly parallel with the bottom surface of the paper binder 100 by the supporting plate 103.

Moreover, as shown in FIG. 2, FIG. 4A, and FIG. 4B, the top surface of the anterior base 101c is provided with the holding portion 108 on the frontward (X3 direction) side, and with a first guide brace member 106 (Refer to FIG. 4A) on the rearward (X4 direction) side. At a position between these, a pair of first cylinder portions 107 is provided side by side. The holding portion 108 supports the pair of ligulate-strip processing portions 123 and the pair of incising blades 124 so that their respective blade parts face upward. Moreover, the holding portion 108 supports each of the ligulate-strip processing portions 123 so that they are rotatable via the rotation shaft 124a. The ligulate-strip processing portions 123 are supported at a position where, for example, lines extending in the projection direction of the projections 123e of the ligulate-strip processing portions 123 intersect. Moreover, the incising blades 124 are supported so that the orientations of the blade parts are roughly perpendicular to the projection directions of the projections 123e of the ligulate-strip processing portions 123. This configuration is for operations whereby the projections 123e pass through the engaging holes 124c of the incising blades 124 and press the ligulate strips S into the incising blades 124 (refer to FIG. 6B).

The first guide brace member 106 is arranged on the frontward (X3 direction) side of the anterior base 101c. The first guide brace member 106 is erected upward as shown in FIG. 4A. To enable it to pass through the interior of a lower holding portion 121g of the mounting base 121 (described later) (FIG. 4B), the diameter of the first guide brace member 106 is formed to be less than the internal diameter of the lower holding portion 121g.

As shown in FIG. 2, between the first guide brace member 106 and the holding portion 108 in the frontward direction of the anterior base 101c, a pair of the first cylinder portions 107 erected upward is arranged side by side. To enable penetration by the second guide brace member 120g of the pressing portion 120, the diameter of the first cylinder portion 107 is greater than that of the second guide brace member 120g. Furthermore, to enable it to pass through the interior of the first guide hole 121c of the mounting base 121, the diameter of the first cylinder portion 107 is formed to be smaller than that of the first guide hole 121c (refer to FIG. 9). The engagement relationship of the first guide hole 121c and the second guide brace member 120g is described later.

The first elastic member 105 is wrapped around the first cylinder portion 107 of the anterior base 101c. The first elastic member 105 has a height that reaches the lower surface of the mounting surface of the mounting base 121. The width of the first elastic member 105 is formed to be wider than the first cylinder portion 107 to enable expansion and contraction around the first cylinder portion 107. Examples of the first elastic member 105 include a coil spring or a rubber member.

(Handle 110)

As shown in FIG. 2, FIG. 4A, and FIG. 4B, the handle 110 has the handle cover 110d and the handle frame 110e. Moreover, as shown in FIG. 5A and FIG. 5B, the handle frame 110e has a top plate and side plates. The top plate covers from the protruding end 110a of the handle 110 to the side of the rotation shaft 111. The side plates are roughly perpendicular to the top plate and extend downward, and face each other. Each of the side plates of the handle frame 110e is arranged at a position enclosed between the base 101 and the side plates of the supporting plate 103. At positions corresponding to the bearings 103a of the supporting plate 103, each of the side plates is provided with the rotation shaft through-holes 110f through which the rotation shaft 111 passes. As a result of passing the rotation shaft 111 through the rotation shaft through-holes 110f and also passing the rotation shaft 111 through the supporting plate 103, the handle frame 110e is rotatably supported by the supporting plate 103. At positions between the protruding end 110a of the handle 110 and the rotation shaft 111, the side plates of the handle frame 110e are provided with pressure shaft through-holes 110g. As a result of passing the pressure shaft 112 through the pressure shaft through-holes 110g, the handle frame 110e supports the pressure shaft 112. The pressure shaft 112 does not come into contact with the supporting plate 103.

As shown in FIG. 2, the handle cover 110d is formed to be one size larger than the handle frame 110e, and is also formed with a wider width than the supporting plate 103. Moreover, as shown in FIG. 1A and FIG. 1B, the handle cover 110d covers the handle frame 110e and the supporting plate 103.

Here, in a paper binder with a configuration in which the side plates of the handle frame enclose the supporting plate that acts as a base, when the handle is pressed down, the base-side surface (lower surface) of the handle abuts the upper edge of the supporting plate. Therefore, if the height of the supporting plate is great, the rotational range of the handle becomes limited. That is, when the handle is lowered, the lower surface of the handle abuts the upper edge of the supporting plate before nearing the base. Even if the handle is pressed down further, it is blocked by the upper edge of the supporting plate and will not go down. However, in a paper binder that forms the ligulate strips S and inserts them into the incisions C to bind paper sheets, it is necessary to not only punch holes into the paper sheets but also to insert the ligulate strips S, and therefore, the distance of the upward and downward movement of the ligulate-strip processing portion including the punch blades becomes greater compared to that of a hole puncher. In other words, it is necessary to secure the stroke of the ligulate-strip processing portion. Consequently, in this type of configuration, by making the angle between the base and the handle great, the stroke length of the ligulate-strip processing portion is secured. However, when this angle becomes great, the operability of the paper-binding process deteriorates.

Regarding this point, the paper binder 100 according to the present embodiment has a configuration in which the handle frame 110e is enclosed between the supporting plate 103. That is, when the handle frame 110e is pressed down, the situation in which the lower surface of the handle 110 abuts the upper edge of the supporting plate 103 does not occur. In other words, the rotational range of the handle is not limited by the height of the supporting plate 103. Consequently, the stroke length of the upward and downward movement of the ligulate-strip processing portion 123 is secured and the operability of the paper-binding process is also secured.

Moreover, according to the configuration of the present embodiment, the protruding end 110a of the handle 110 comes near the posterior base 101a as shown in FIG. 4B. At this point, in the vicinity of the rotation shaft 111, the upper surface of the handle frame 110e may fall below the upper edge position of the supporting plate 103. When this type of situation occurs, if the hand of the operator pressing the handle 110 down is near the rotation shaft 111, the height difference between the supporting plate 103 and the upper surface of the handle frame 110e may disrupt the operation and cause a problem in the pressing-down operation. Regarding this point, in the paper binder 100 of the present embodiment, the handle cover 110d is provided and covers the handle frame 110e together with the entire supporting plate 103. Consequently, even if the hand of the operator pressing the handle 110 down is near the rotation shaft 111, the operation is not disrupted, and the occurrence of disruptions to this type of operation of pressing the handle 110 down is prevented.

Furthermore, the aperture portion 110c is provided on the handle frame 110e and the handle cover 110d according to the present embodiment on the side of the rotation shaft 111. The aperture portion 110c is formed above a region including at least the reception hole 120a of the pressing portion 120 and the surrounding area of the reception hole 120a. As a result of the aperture portion 110c, the operator is able to recognize the content of the paper sheets mounted toward the base 101 from the handle 110, as well as the hole-punching position and the state of each part of the paper binder 100. In addition to this configuration, by adopting a configuration in which the pressing portion 120 is made transparent as described later, it becomes possible to visually confirm the upper surface of the paper sheets mounted on the mounting base 121. Moreover, the reason for making the position where the aperture portion 110c is formed a region including the reception hole 120a and its surroundings is that the reception hole 120a becomes the hole-punching part relative to the paper sheets, and therefore, that part becomes visible to the operator.

The aperture portion 110c shown in FIG. 1A and FIG. 2, etc. has a roughly U-shape in which the frontward side of the handle 110 has been cut away, and is formed so that the front side is open. However, the “window portion” of the present invention is not limited to the present embodiment. That is, the window portion does not necessarily have to be a formation in which the frontward side is cut away and made open. For example, the aperture portion 110c of FIG. 1A may be partially changed and the upper part of the rotation shaft 111 of the handle 110 may be covered. In other words, the upper surface of the handle 110 may be notched away to create a bridge between the left and right sides of the front edge side of the handle 110. With this type of window portion, a through-hole with a square shape, circular shape, or polygonal shape, etc. is formed in the handle 110.

(Pressing Portion 120)

The pressing portion 120 presses the paper sheets on the mounting base 121 and also presses down the mounting base 121. As shown in FIG. 2, FIGS. 4A-6B, FIG. 9, and FIG. 10, the pressing portion 120 is provided with the reception holes 120a, visual holes 120c, the pressing portion guide 120e, the second guide brace member 120g, the engaging portion 120h, and an upper holding portion 120j.

As shown in FIG. 2 and FIG. 5A, on the lower surface on the side of the base 101, the pressing portion 120 is provided with the reception holes 120a that are able to receive the punch blades 123c and the projections 123e of the ligulate-strip processing portions 123. The reception holes 120a are provided above the position of the ligulate-strip processing portions 123 supported by the holding portion 108 (refer to FIG. 2) of the anterior base 101c. Moreover, the reception holes 120a are formed to a size allowing the projections 123e to be rotated. Furthermore, the reception holes 120a are large enough for the incising blades 124 to also pass through. The position of the reception holes 120a may be adjusted to match the punch blades 123c. Based on this positional adjustment, a guide is formed for the stroke operation of the ligulate-strip processing portions 123 entering the reception holes 120a. The reception holes 120a do not necessarily have to pass through to the upper surface of the pressing portion 120. However, by making the reception holes 120a through-holes as in the present embodiment, it becomes possible to make the hole-punching part visible to the operator.

Similarly, as shown in FIG. 2 and FIG. 5A, on the lower surface of the pressing portion 120, visual holes 120c passing through to the upper surface are provided to secure visibility of the hole-punching part. Furthermore, as in the present embodiment, for the visual holes 120c as well, a configuration that does not pass through to the upper surface of the pressing portion 120 may be adopted. However, to improve the visibility of the hole-punching part for the operator, in the present embodiment, the visual holes 120c are formed as through-holes. Via the aperture portion 110c of the handle 110 and the visual holes 120c, it becomes easier for the operator to visually confirm the hole-punching part of the paper sheets to be hole-punched as well as the surrounding region.

Moreover, as shown in FIG. 2 and in FIG. 5A, FIG. 5B, FIG. 7, FIG. 8A, and FIG. 10, the anterior part of the lower surface of the pressing portion 120 is provided with a pair of pressing portion guides 120e that are lined up side by side. The pressing portion guides 120e are roughly columnar and each extend downward, and are penetrated by the second guide holes 121e that are described later. That is, the pressing portion guides 120e act as guides when the pressing portion 120 moves up and down relative to the mounting base 121. Based on the pressing portion guides 120e, it is possible to accurately define the pressing position of the paper sheets. Furthermore, when the paper sheets descends while being pinched by the pressing portion 120 and the mounting base 121, the pressing portion guides 120e make the pressing portion 120 less likely to become misaligned relative to the mounting base 121. As a result, it becomes possible to punch holes after firmly fixing the paper sheets.

Moreover, as shown in FIG. 2 and in FIG. 5A, FIG. 5B, and FIG. 8A, on the lower surface of the pressing portion 120, slightly anterior to the pressing portion guides 120e, the second guide brace members 120g are provided side by side. Furthermore, the second guide brace members 120g are provided at positions corresponding to the first cylinder portions 107 of the anterior base 101c and the first guide holes 121c (refer to FIG. 5A and FIG. 5B). As shown in FIG. 6A, FIG. 6C, FIG. 9, and FIG. 10, the second guide brace members 120g are roughly columnar and each extend downward. Moreover, the second guide brace members are penetrated by the first cylinder portions 107 that are passed through the first guide holes 121c of the mounting base 121 as described later. That is, the second guide brace members 120g act as guides for when the pressing portion 120 moves upward and downward relative to the anterior base 101c together with the mounting base 121. Based on the second guide brace members 120g, when the paper sheets descend while being pinched by the pressing portion 120 and the mounting base 121, it becomes possible for the second guide brace members 120g to make the pressing portion 120 less likely to become misaligned relative to the anterior base 101c. As a result, it becomes possible to accurately punch holes in the paper sheets using the paper binder 100.

As shown in FIG. 2, FIG. 7 and FIG. 8A, on the upper surface of the pressing portion 120, the engaging portions 120h that are erected upward are provided on the left and right sides. On the engaging portions 120h, apertures that face each other are formed. In the apertures of the engaging portions 120h, the pressure shaft 112 is able to move in the forward and backward directions inside. That is, the apertures are penetrated by the pressure shaft 112 that also passes through the handle frame 110e. Based on the engaging portions 120h, the handle 110 and the pressing portion 120 are coupled.

As described later, after the insertion of the ligulate strips by the paper binder is complete, the ligulate strips that bind the paper sheets have a thickness corresponding to the number of sheets to be bound. The ligulate strips that have this thickness may become caught in the through-holes 121a of the mounting base 121 or the reception holes 120a of the pressing portion 120. Furthermore, the ligulate strip part may become caught in each hole and remain stuck in each hole. When such a situation occurs, the paper sheets connected to the ligulate strips also become caught and stuck between the pressing portion 120 and the mounting base 121 together with the ligulate strips. On the other hand, the handle 110 alone is biased by the second elastic member 125 and returns to its original position. However, due to the ligulate strips that are caught, the pressing portion 120 does not return to its original position. This is because the biasing force of the second elastic member 125 required for pressing the papers is not as strong as the biasing force of the first elastic member 105, and is not sufficient for resolving the catching of the pressing portion 120 in this case.

Consequently, when this type of situation occurs, it is necessary to resolve the catching of the paper sheets and return the paper binder 100 to its original state. However, this operation is not easy. For example, by forcibly pulling the caught paper sheets, it may be possible to free the paper sheets and return the pressing portion 120 to its original position, but with this method, there is a risk that the bound paper sheets may be torn. In relation to this point, in the paper binder 100 of the present embodiment, the handle 110 and the pressing portion 120 are linked via the engaging portion 120h and the pressure shaft 112. Consequently, after the insertion of the ligulate strips is complete, even if the pressing portion 120 does not return to its original position with the biasing force of the second elastic member 125, by manually returning the handle 110 to its original state, it is possible to restore the position of the linked pressing portion 120. In other words, the front edge part, etc. of the ligulate strips do not come out from the through-holes 121a or the reception holes 120a, and even if the pressing portion 120 does not return to its original position, it can be manually returned to its original position. Furthermore, this operation is easy. Moreover, when the pressing portion 120 does not return to its original state, it is possible to rotate the handle 110 upward and remove the front end of the ligulate strips from the through-holes 121a and then remove the ligulate strips caught in the reception holes 120a. Consequently, it becomes possible to prevent damage to the bound paper sheets.

Moreover, as shown in FIG. 5A and FIG. 5B, on the lower surface of the pressing portion 120, the upper holding portion 120j (FIG. 2, FIG. 4) that supports the upper edge part of the second elastic member 125 is provided at a position enclosed by the pressing portion guides 120e. Examples of the second elastic member 125 include a coil spring or a rubber member.

Moreover, the entirety of the pressing portion 120 is configured by a transparent member. It is also possible to not configure the entirety with a transparent member and to make the reception holes 120a and the region surrounding the reception holes 120a transparent members. That is, as long as the area above at least the through-holes 121a of the mounting base 121 and the region surrounding the through-holes 121a is transparent, it is possible for the operator to confirm the state of the hole-punching part and its surroundings on the paper sheets. Moreover, it is not necessary to configure the pressing portion 120 with a transparent member, and it may be configured as a mesh or a sieve to allow the operator to confirm the state of the hole-punching part and its surroundings on the paper sheets.

Moreover, in the paper binder 100 according to the present embodiment, the punch blades 123c that punch holes and form the ligulate strips S, the incising blades 124 that form the incisions C, and the projections 123e that fold over the ligulate strips S, etc. are all arranged on the side of the base 101. According to this type of configuration, on the pressing portion 120 on the side of the handle 110, it is sufficient to form at least the reception holes 120a that receive the blades, etc. of the ligulate-strip processing portions 123 and the incising blades 124. That is, with this configuration, it is possible to reduce the space used by the pressing portion 120. With this space reduction, it is possible to reduce the distance between, for example, the pressure shaft 112 and the rotation shaft 111. As a result, manual force on the handle 110 can be applied efficiently, and it becomes possible to reduce the hole-punching load.

Moreover, through this space reduction, it is possible to arrange the rotation shaft anteriorly relative to the pressing portion 120 and to lower the rotation shaft 111 based on the height of the upper surface of the pressing portion 120. By lowering the height of the rotation shaft 111, it becomes possible to suppress the height of the supporting plate 103. As a result, it becomes possible to suppress increases in the overall size of the paper binder 100. Furthermore, when making the paper binder 100 a handheld tool, because it is possible to reduce the distance between the protruding end 110a of the handle 110 and the posterior edge of the posterior base 101a, it becomes possible to improve the operability of paper-binding operations.

(Mounting Base 121)

The mounting base 121 supports one edge of the paper sheets using the upper surface as the mounting surface, and pinches the paper sheets with the pressing portion 120. When the mounting base 121 is pressed down while pinching the paper sheets, the paper sheets are pressed for the blade parts of the punch blades 123c and the incising blades 124. As a result of this series of operations, the punched holes and the incisions are formed. The mounting base 121 is provided with the through-holes 121a (FIG. 2, FIG. 6A), the first guide holes 121c (FIG. 2, FIG. 5A, FIG. 5B, FIG. 9), the second guide holes 121e (FIG. 2, FIG. 5A, FIG. 5B), the lower holding portion 121g (FIG. 2, FIG. 9), and a gauge base 121j (FIG. 2, FIG. 4A, FIG. 7).

Moreover, as shown in FIG. 2 and FIG. 6A, on the paper-sheet mounting surface of the mounting base 121, the through holes 121c through which the punch blades 123c and the projections 123e can pass are provided. The through-holes 121a are provided corresponding to the position of the ligulate-strip processing portion 123 (i.e., the position of the holding portion 108 of the anterior base 101c supporting the ligulate-strip processing portion 123. Moreover, the through-holes 121a are formed at a size that allows the projections 123e of the ligulate-strip processing portion 123 to be rotated. Furthermore, the through-holes 121a have a size that allows the incising blades 124 to pass through. The through-holes 121a guide the ligulate-strip processing portion 123 and the incising blades 124 to the paper sheets on the mounting surface.

Moreover, as shown in FIG. 2, FIG. 5A, FIG. 5B, and FIG. 9, a pair of the first guide holes 121c is provided on the mounting surface of the mounting base 121. The first guide holes 121c are provided at a position corresponding to the first cylinder portions 107 of the anterior base 101c. The first guide holes 121c are formed to have a greater diameter than the first cylinder portions 107 and the second guide brace members 120g as shown in FIG. 5A and FIG. 9. In other words, the first guide holes 121c are guided by the first cylinder portions 107 that penetrate the second guide brace members 120g and are used for positional alignment when moving the mounting base 121 up and down relative to the anterior base 101c.

Moreover, as shown in FIG. 2, FIG. 5A, and FIG. 5B, on the posterior side of the mounting surface of the mounting base 121, a pair of the second guide holes 121e is provided. The second guide holes 121e are provided at a position corresponding to the pressing portion guides 120e on the pressing portion 120. The second guide holes 121e are penetrated by the pressing portion guides 120e and guide the upward and downward movement of the pressing portion 120 relative to the mounting base 121.

Moreover, as shown in FIG. 2 and FIG. 9, on the mounting base 121, at a position enclosed by each of the second guide holes 121e, the lower holding portion 121g that supports the lower edge part of the second elastic member 125 is provided.

Moreover, as shown in FIG. 6A and FIG. 6B, on the mounting base 121, raised portions 121f are provided side by side at a position corresponding to a hook portion 123g of the ligulate-strip processing portion 123. The raised portions 121f each extend downward. According to this type of configuration, when the mounting base 121 descends, the front end abuts the hook portion 123g of the ligulate-strip processing portion 123 and presses down the hook portion 123g. When the hook portion 123g is pressed down, the entirety of the ligulate-strip processing portion 123 rotates about the rotation shaft 124a.

(Ligulate-Strip Processing Portions 123 and Incising Blades 124)

Next, with reference to FIG. 2, FIG. 4A, FIG. 5A, FIGS. 6A-6D, and FIG. 11, the configuration of the ligulate-strip processing portions 123, the rotational direction as well as the connection direction relative to the holding portion 108, and the configuration of the incising blades 124 will be described. FIG. 11 is a schematic diagram showing a state in which the corners of the paper sheets have been bound by the paper binder 100 according to the present embodiment.

As shown in FIG. 2 and FIG. 6A, on its lower edge on the side to which the anterior base 101c is attached, the ligulate-strip processing portion 123 is provided with rotational bases 123a through which the rotational axes 124a penetrate, and on its upper edge, it is provided with the punch blades 123c that punch holes in paper sheets. Furthermore, the projections 123e that are formed contiguously with the punch blades 123c are provided facing the lateral directions from the upper edge of the ligulate-strip processing portions 123. Moreover, from the lateral sides of the rotational bases 123a, the hook portions 123g that are perpendicular to the height direction (upward direction; refer to X1 in FIG. 1) of the ligulate-strip processing portions 123 are provided. The “height direction” refers to the direction from the rotational bases 123a to the front end of the punch blades 123c.

As shown in FIG. 2, the ligulate-strip processing portions 123 are supported by the bearings 108a of the holding portion 108 of the anterior base 101c via the rotational axes 124a. Consequently, the ligulate-strip processing portions 123 are rotatable about the rotational axes 124a. As described above, the pressing portion 120 and the mounting base 121 are provided with the reception holes 120a and the through-holes 121a, but as shown in FIG. 2 and FIG. 5A, these are formed in accordance with the installation angles and sizes of the ligulate-strip processing portions 123 and the incising blades 124 relative to the forward and backward directions of the paper binder 100. That is, each of the ligulate-strip processing portions 123 is supported by the holding portion 108 with a prescribed angle α (FIG. 11) relative to each other. In other words, hypothetical extension lines connecting the projection directions of the projections 123e form the prescribed angle α.

Moreover, the incising blade 124 is provided enclosed by the punch blades 123c. As with the ligulate-strip processing portions 123, the incising blade 124 is supported by the holding portion 108, and the blade part is formed as a flat plate. The width direction of the blade part is roughly perpendicular to the projection direction of the projections 123e. Furthermore, as shown in FIG. 4A, the incising blade 124 is provided with the engaging hole 124c through the projections 123e of the ligulate-strip processing portions 123 are able to pass through.

According to the configuration described above, the punch blades 123c rotate in mutually facing directions and fold over each of the ligulate strips S. As a result, the ligulate strips S formed by the punch blades 123c are folded over in mutually facing directions by the rotation of the ligulate-strip processing portions 123 (refer to FIG. 11). Moreover, the width directions of incising blades 124 are roughly perpendicular to the rotational directions of the projections 123e. Furthermore, on the incising blades 124, the engaging hole 124c that passes through the projections 123e of the ligulate-strip processing portions 123 is formed. Consequently, the ligulate strips S folded over by the projections 123e are pressed into the engaging hole 124c, and when the incising blade 124 descends, the ligulate strips S remain pressed into the engaging hole 124c and pass through the paper sheets and are pressed into the incisions C.

However, the means of pressing the ligulate strips S into the incisions C is not limited to a method using the incising blades 124 and the engaging hole 124c. For example, a configuration may be used in which the projections 123e rotated until the position of the incisions C and press the ligulate strips S into the incisions C. Moreover, the projections 123e that press in the ligulate strips S do not necessarily have to be formed in an integrated manner with the punch blades 123c, and they may be configured as separate members.

As a result, as shown in FIG. 11, the ligulate strips S that have been pressed into the incisions C are facing each other, and hypothetical extension lines of the projection directions of the ligulate strips S face each other or intersect. Furthermore, as described above, one of the ligulate-strip processing portions 123 according to the present embodiment is attached to the bearing 108a with the prescribed angle α relative to the other ligulate strip processing portion 123. Here, in the paper binder 100 of the present embodiment, the prescribed angle α is defined as being around 90° to 150°, and they are attached to the bearing 108a so that the extension lines of the projection direction of the projections 123e form a roughly V-shape. This type of configuration is suitable for binding the corners of paper sheets. That is, when there is any printing, etc. on the corner region of paper sheets being bound, if the ligulate strips S or the punched holes overlap with that printed part, there is a risk that it may not be able to confirm the printed content of that part. In relation to this point, if the angle α is around, for example, 90° to 150°, it is possible to avoid this type of situation. The angle α is, as shown in FIG. 11, the angle observed when facing the insertion direction of the paper sheets relative to the paper binder 100.

By defining the angle α in this manner, it is possible to prevent the occurrence of a turning direction that makes the binding easy to undo. If only one of the ligulate strips S is present, when the paper sheets are turned in the direction opposite to the direction of insertion into the incisions C, the ligulate strip S ends up being removed from the incisions C. Moreover, even if there are multiple ligulate strips S, if each ligulate strip S is inserted in a reverse-facing manner relative to the incisions C, they may again end up being removed from the incisions C. However, in the bound part of paper sheets bound by the paper binder 100 of the present embodiment, the extension line in the insertion direction of one set of ligulate strips S into the incisions C intersects with the extension line in the insertion direction of the other set of ligulate strips S into the incisions C. Consequently, even if the paper sheets are turned in the direction opposite to the insertion direction of one set of ligulate strips S, the other set of ligulate strips S prevents the ligulate strips S from being removed from the incisions C. In other words, it is possible to suppress or prevent movements of the paper sheets that cause one set of ligulate strips S to become removed from the incisions C with the presence of the other set of ligulate strips S pressed into the incisions C. Consequently, it is possible to secure the binding strength between the paper sheets. Moreover, because the paper sheets are bound by the ligulate strips S, multiple paper sheets are bound without using a binding material such as a staple or adhesive paste, and it is therefore possible to prevent situations causing problems in a shredder or an ADF (Auto Document Feeder). Furthermore, there is no need to refill the binding material, and it is possible to avoid troublesome replacement operations of binding material after continuous use.

Furthermore, as shown in FIG. 2, FIG. 6C, and FIG. 6D, the ligulate-strip processing portions 123 are attached to the holding portion 108 via the third elastic members 126. For the third elastic members 126, members that provide a bias in the direction opposite from the rotational direction of the ligulate-strip processing portions 123 are used. Even if the ligulate-strip processing portions 123 are rotated once, the third elastic members 126 are configured to return to the original position using a biasing force returning to the original position after being deformed like spring coils, for example.

### (Operations)

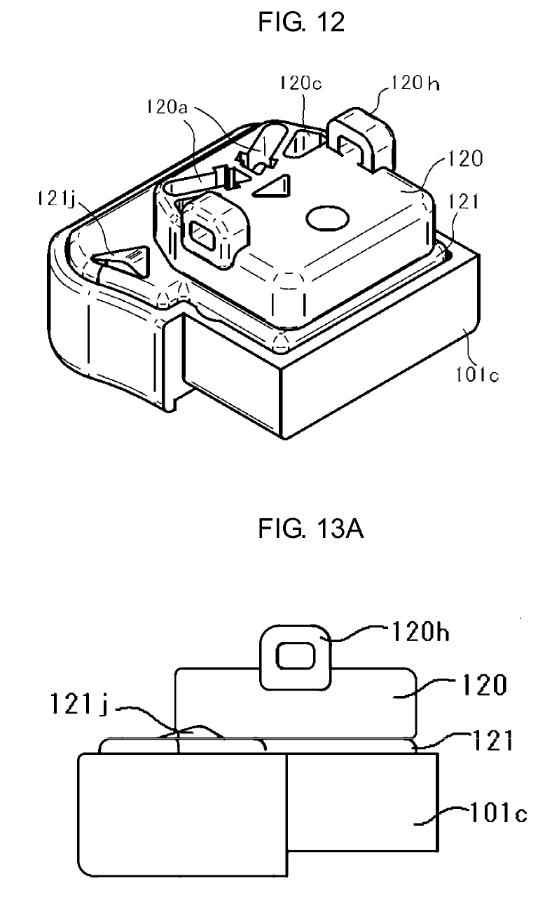

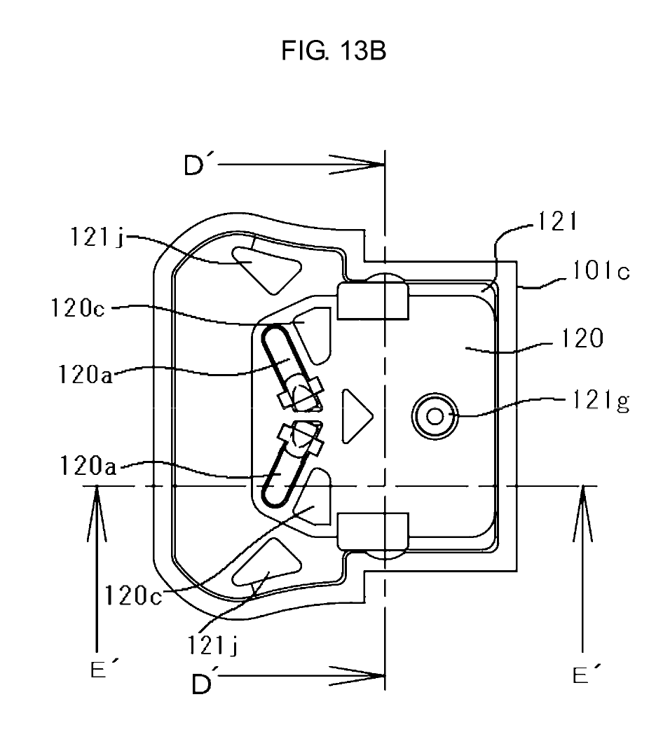

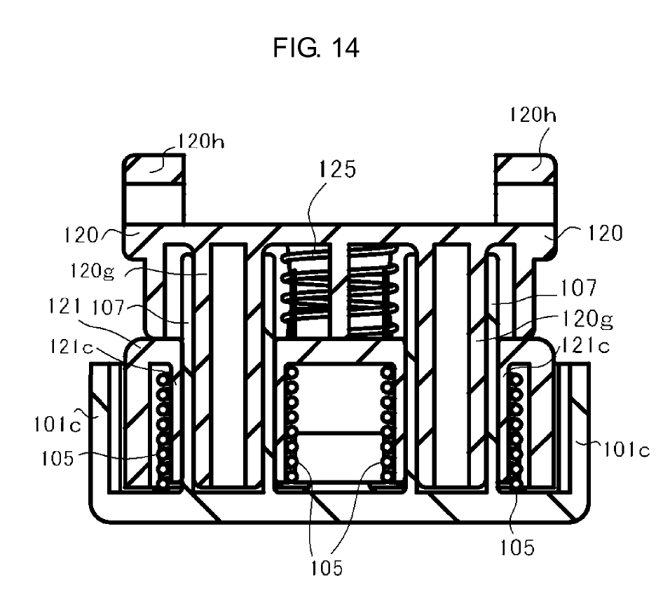

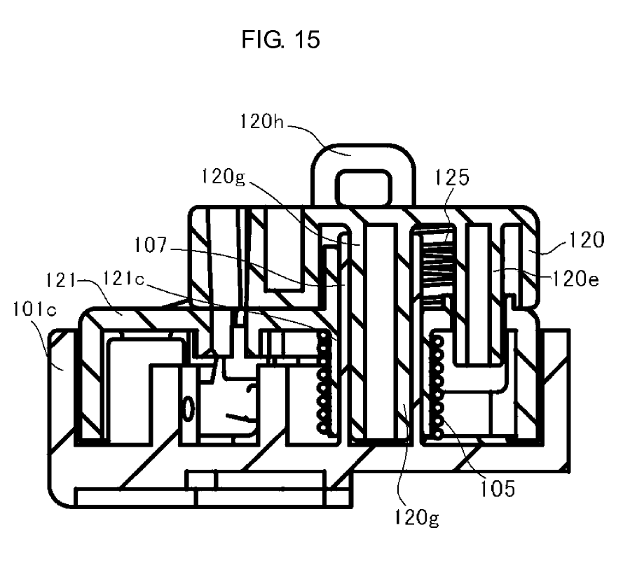

Next, operations of the ligulate-strip processing portions 123 and the incising blades 124 according to the above configuration, as well as operations of the pressing portion 120 and the mounting base 121, are described with reference to FIG. 4A, FIG. 4B, FIG. 5A, FIG. 5B, FIGS. 6A-6D, FIGS. 7-10, and FIGS. 12-15. FIG. 12 is a schematic perspective view of the paper binder 100 according to the present embodiment, showing the positional relationships of the pressing portion 120, the mounting base 121, and the anterior base after the rotation of the handle 110. FIG. 13A is a schematic right lateral view of the paper binder 100 according to the present embodiment, showing the positional relationships of the pressing portion 120, the mounting base 121, and the anterior base 101c after the rotation of the handle 110. FIG. 13B is a schematic top view of the paper binder 100 according to the present embodiment, showing the positional relationships of the pressing portion 120, the mounting base 121, and the anterior base 101c after the rotation of the handle 110. FIG. 14 is a cross-sectional diagram of the paper binder 100 according to the present embodiment along the part D′-D′ of FIG. 13B, showing an overview of the positional relationships of the pressing portion 120, the mounting base 121, and the anterior base 101c after the rotation of the handle 110. FIG. 15 is a cross-sectional diagram of the paper binder 100 according to the present embodiment along the part E′-E′ of FIG. 13B, showing an overview of the positional relationships of the pressing portion 120, the mounting base 121, and the anterior base 101c after the rotation of the handle 110.

(State Before Pressing Down the Handle)

As shown in FIG. 4A, before the rotation of the handle 110, the pressing portion 120 and the mounting base 121 are arranged with an interval between them. This state is the result of the second elastic members 125 providing a bias to separate the pressing portion 120 from the mounting surface of the mounting base 121 as shown in FIG. 9 and FIG. 10. The part where the prescribed interval has been opened is the region where the multiple paper sheets to be bound by the paper binder 100 are placed. Moreover, as shown in FIG. 8A, the anterior edge part of the paper-sheet placement region between the pressing portion 120 and the mounting base 121 acts as the insertion slot 104.

(State at the Start of Pressing Down the Handle)

When transitioning from FIG. 4A to FIG. 4B (i.e., when the handle 110 starts to be rotated), the pressure shaft 112 supported by the handle 110 pressed down the upper surface of the pressing portion 120 against the biasing force of the second elastic member 125 of the pressing portion 120. The engaging portions 120h of the pressing portion 120 are penetrated internally by the pressure shaft 112 so as to enclose both edges of the pressure shaft 112. Furthermore, the engaging portions 120h are formed with an allowance to allow the pressure shaft 112 to slide inside them. Based on the configurations of the engaging portions 120h, when the pressure shaft 112 pressed down the pressing portion 120, it slides roughly forward inside the engaging portions 120h. This is an action to change the orientation of the force of the pressure shaft 112 trying to rotate rearward (toward the protruding end 110a) together with the rotation of the handle 110 into a downward, roughly straight pressing force. That is, because the second guide brace members 120g descend in a roughly straight line toward the first cylinder portions 107 of the anterior base 101c, it becomes possible to use the hole-punching load that presses down the pressing portion 120 and the mounting base 121 efficiently.

Moreover, when the pressure shaft 112 supported by the handle 110 presses down the pressing portion 120, the pressing portion guides 120e pass through the inside of the second guide holes 121e of the mounting base 121. That is, the pressing portion 120 is guided by the second guide holes 121e and the entirety moves toward the front surface of the mounting base 121.

(State at the Start of Pressing Down the Mounting Base)

When the pressing portion 120 reaches the upper surface (mounting surface) of the paper sheets on the mounting base 121, the paper sheets are pinched between the upper surface of the mounting base 121 and the anterior side of the lower surface of the pressing portion 120. When the pressure shaft 112 is pressed down further, the lower surface of the pressing portion 120 starts to press down the mounting base 121 while the paper sheets remain gripped. At this time, as shown in FIG. 9, the second guide brace members 120g of the pressing portion 120 pass through the inside of the first cylinder portions 107 that have been penetrated by the first guide holes 121c. Consequently, the pressing portion 120 and the mounting base 121 are guided by the first cylinder portions 107 of the anterior base 101c and move downward against the biasing force of the first elastic members 105.

Furthermore, as shown in FIG. 5A and FIG. 5B, the pressure shaft 112 is provided almost directly above the second guide brace members 120g relative to the pressing portion 120. That is, it is arranged roughly on a line extending from the direction in which the first cylinder portions 107 provided with the first elastic member 105 are erected to the direction in which the second guide brace members 120g face. The first elastic members 105 provide an upward bias for the mounting base 121 to support the adjustment of the hole-punching load to the optimum level for punching holes in paper sheets. From directly above the direction in which the first cylinder portions 107 provided with the first elastic members 105 are erected, the pressure shaft 112 presses down the pressing portion 120. Consequently, it becomes possible to transmit the hole-punching load that presses down the pressing portion 120 and the mounting base 121 more efficiently.

### (State at the Start of Hole-Punching)

When the mounting base 121 starts to be pressed down in this way, the punch blades 123c of the ligulate-strip processing portions 123 supported by the holding portion 108 abut the bottom surface of the paper sheets on the mounting surface of the mounting base 121. When the mounting base 121 is pressed down further, they press against the bottom surface of the paper sheets and the punch blades 123c on the front end punch holes in the paper sheets. Moreover, the incising blades 124 are also pressed against and insert incisions C on the inside of the holes punched in the paper sheets. Here, the term “inside” refers to the side toward the centerline of the paper binder 100 connecting the forward and backward directions of the paper binder 100.

### (State During the Paper-Binding Process)

When the hole-punching and the formation of the ligulate strips S and the incisions are complete and the mounting base 121 descends further, as shown in FIGS. 12-15, the lower edge of the second guide brace members 120g of the pressing portion 120 come near to the upper surface (basal surface) of the anterior base 101c. At this time, the upper surface (the surface on the side of the pressing portion 120) of the hook portions 123g on the base-side of the ligulate-strip processing portions 123 abuts the front ends of the raised portions 121f of the mounting base 121. As a result, as shown in FIG. 6B, the ligulate-strip processing portions 123 rotate. When the ligulate-strip processing portions 123 rotate, the ligulate strips S formed by the hole-punching are folded over downward (toward the incisions C) by the projections 123e. The ligulate strips S that have been folded over by the projections 123e are pressed into the engaging holes 124c, and when the incising blades 124 descend further, the ligulate strips S pass through the paper sheets while remaining pressed into the engaging holes 124c, and are pressed into the incisions C. In this way, multiple paper sheets are bound together.

(State from the Time of Completion of the Paper-Binding Process to Handle Release)

As shown in FIG. 6C and FIG. 6D, due to the third elastic members 126, the ligulate-strip processing portions 123 are biased so as to be supported at a position where the punch blades 123c face upward. After the ligulate-strip processing portions 123 are rotated and the ligulate strips S have been pressed into the incisions C by the projections 123e and the engaging hole 124c of the incising blades 124, when the pressing down of the handle 110 is released, the mounting base 121 is biased upward by the first elastic members 105 and is elevated. The hook portions 123g of the ligulate-strip processing portions 123 have been pressed down by the raised portions 121f and rotated against the biasing force of the third elastic members 126, but when the pressing down of the handle is released, the hook portions 123g are released from the pressing down of the raised portions 121f as the mounting base 121 is elevated. Furthermore, the ligulate-strip processing portions 123 return to their original positions due to the biasing force of the third elastic members 126.

### (Other Configurations)

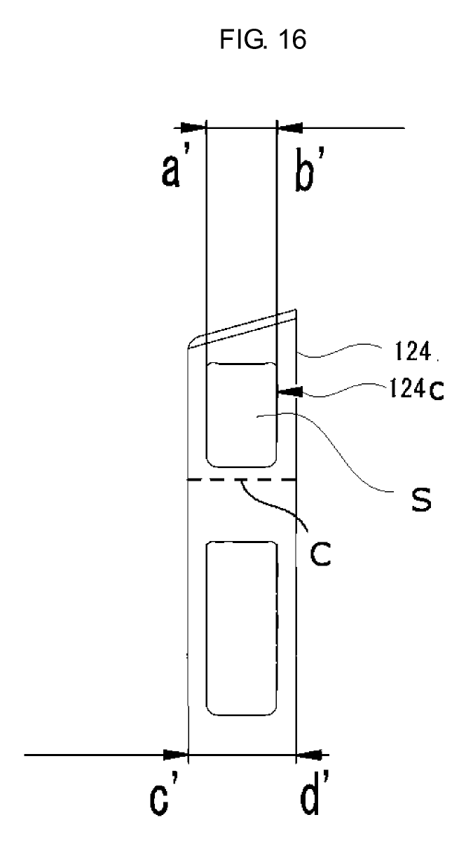

Next, with reference to FIG. 2, FIG. 8B, and FIG. 16, peripheral component parts of the paper binder 100 will be described. FIG. 16 is a schematic diagram that conceptually shows the difference in width between the incising blade 124 of the paper binder according to the embodiment and a ligulate strip formed through hole-punching.

(Gauge Base 121j)

With reference to FIG. 2, FIG. 7, and FIG. 8B, the gauge bases 121j of the paper binder 100 are described. As shown in FIG. 2 and FIG. 8B, the edge parts of both sides on the upper surface (mounting surface) of the mounting base 121 are provided with a pair of the gauge bases 121j. The gauge bases 121j, 121j are each raised from the upper surface. The upper surfaces from which they are raised are formed as flat planes, for example. The gauge bases 121j, 121j are suitable members for setting a binding portion on the corner part of paper sheets. As shown in FIG. 2, the gauge bases 121j, 121j guide the corner part of the paper sheets to be held in place through the through-holes 121a, 121a. That is, the gauge bases 121j, 121j are formed so that the corner regions of the paper sheets being inserted match as they move toward the intersection of the through-holes 121a, 121a. When setting the binding portion to the corner part of the paper sheets, by inserting the paper sheets into the through-holes 121a, 121a along the lateral surfaces of the gauge bases 121j, 121j, the user is able to easily perform positional alignment.

Furthermore, the respective heights of the gauge bases 121j, 121j are formed to be lower than the height from the upper surface of the mounting base 121 to the lower surface of the pressing portion 120. Consequently, when the user does not wish to use the gauge bases 121j, 121j, the user passes the paper sheets through over the gauge bases 121j, 121j. When using the gauge bases 121j, 121j, it is possible to perform the positional alignment described above. In other words, the gauge bases 121j, 121j are configurations allowing positional alignment to be performed when necessary, and it is possible to select the method of use desired by the user.

### (Width of Incising Blades 124)

As shown in FIG. 16, the relationship between the widths of the incisions C and the widths of the ligulate strips S is, for example, as described below. Here, for ease of explanation, as shown in FIG. 16, the widths of the ligulate strips S are denoted as a′b′, and the widths of the incisions C are equal to the widths of the incising blades 124 and are denoted as c′ d′. First, because the ligulate strips S are pressed into the incisions C, the difference between the widths of the incisions C and the widths of the ligulate strips S may be expressed as: c′d′>a′b′.

Here, when fixing the ligulate strips S pressed into the incisions C to prevent their movement and thereby secure adhesive strength, the widths of the incisions C become almost equal to the widths of the ligulate strips S (c′d′−a′b′≅0 mm). However, the bound paper sheets may each be rolled individually by a browser. That is, if the widths of the incisions C are made almost equal to the widths of the ligulate strips S and no difference in width is set, there is a risk that the edge parts of the incisions C may be torn. This is because a great load is applied to the point of contact between the widthwise edge parts of the incisions C and the widthwise edge parts of the ligulate strips S due to the rolling movement. Consequently, based on considerations of the strength of the edge parts of the incisions C, the difference between the widths of the incisions C and the widths of the ligulate strips S is set to, for example, 2 mm or more. In other words, the widths of the incising blades 124 are formed to open a length of around 1 mm from each of the widthwise edge parts of the ligulate strips S to the widthwise edge parts of the incisions C.

### (Actions and Effects)

Next, actions and effects of the paper binder 100 according to the present embodiment will be described.

In the paper binder 100 according to the present embodiment, the handle 110 is provided with the aperture portion 110c. Furthermore, the entirety of the pressing portion 120 is configured by a transparent member. Therefore, the upper surface of the paper sheets mounted on the mounting base 121 is visible through the aperture portion 110c and the pressing portion 120. Consequently, the operator performing the paper-binding process is able to punch holes in the paper sheets after confirming the hole-punching part. As a result, it becomes easy to confirm the paper-binding part of the paper sheets. Furthermore, it is also possible to perform paper-binding while avoiding printed parts of the paper sheets, and it is therefore possible to prevent the risk of creating problems for browsing the paper sheets. Moreover, because the paper sheets are bound together by the ligulate strips S, it is possible to bind multiple paper sheets without using any binding material such as a staple or adhesive paste. Consequently, it is possible to avoid situations in which problems are accidentally caused with a shredder or an ADF. Furthermore, because there is no binding material used for the paper-binding process, there is no need for any operation to replenish any binding material. Consequently, it is possible to avoid troublesome operations to replace binding materials even after continuous use of the paper binder.

Moreover, in the paper binder according to the present embodiment, the difference between the widths of the incisions C and the widths of the ligulate strips S is set to be, for example, 2 mm or more. That is, the widths of the incising blades 124 are formed to open a length of around 1 mm from each of the widthwise edge parts of the ligulate strips S to the widthwise edge parts of the incisions C. Consequently, as a result of reducing the load applied to the point of contact between the widthwise edge parts of the incisions C and the widthwise edge parts of the ligulate strips S when individual sheets are rolled, it is possible to avoid the risk of the edge parts of the incisions C tearing.

Moreover, in the paper binder 100 according to the present embodiment, as a first step, paper sheets are held by the pressing portion 120, and then as a second step, upon adjusting the hole-punching load, holes are punched in the paper sheets being held. As a result, because the bound paper sheets are unlikely to involve misalignment between individual sheets, a neat finish is obtained and adhesive strength is secured. Furthermore, as shown in FIG. 11, in the paper binder 100 of the present embodiment, when the angle α formed between the ligulate strips S is set to around 90° to 150°, this is suitable for binding the corners of the paper sheets. That is, it is possible to avoid the risk of making it difficult to see printed parts of the corner regions of the bound paper sheets.

The pressure shaft 112 of the paper binder 100 according to the embodiment is arranged approximately on a line extending from the direction in which the first cylinder portion 107 provided with the first elastic member 105 is erected to the direction in which the second guide brace member 120g faces. Furthermore, the first elastic member 105 biases the mounting base 121 upward to support the adjustment of the hole-punching load to an optimum level for punching holes in the paper sheets. From directly above the direction in which the first cylinder portion 107 provided with the first elastic member 105 is erected, the pressure shaft 112 presses down the pressing portion 120. Consequently, it becomes possible to transmit the hole-punching load that presses down the pressing portion 120 and the mounting base 121 with greater efficiency.

In the paper binder 100 according to the present embodiment, the handle frame 110e is enclosed between the supporting plate 103, and therefore, even if the handle frame 110e is pressed down, the situation in which it abuts the upper edge of the supporting plate 103 does not arise. In other words, the rotational range of the handle is not limited by the height of the supporting plate 103. Consequently, the stroke length of the upward and downward movement of the ligulate-strip processing portions 123 is secured while also securing the operability of the paper-binding process. In addition, the handle cover 110d is provided and covers the handle frame 110e together with the entire supporting plate 103. Consequently, even if the hand of the operator pressing down the handle 110d is near the rotation shaft 111, this does not disrupt the operation, and the occurrence of a situation in which operations to press down the handle 110 are disrupted is prevented.

After the completion of the insertion of the ligulate strips S, even if the handle 110 is returned and the pressing portion 120 is biased by the second elastic members 125, the pressing portion 120 may not return to its original position due to the ligulate strips S of the bound paper sheets being caught, etc. For example, there are cases in which the front edge part of the ligulate strips S does not come out of the through-holes 121a or the reception holes 120a and the pressing portion 120 does not return to its original position. In relation to this point, in the paper binder 100 of the present embodiment, the handle 110 and the pressing portion 120 are linked via the engaging portions 120h and the pressure shaft 112. Consequently, even if the pressing portion 120 does not return to its original position, it is possible to manually return the handle 110 to its original state. Moreover, this operation is easy. Moreover, when the pressing portion 120 does not return to its original state, it is also possible to perform an operation in which the handle 110 is rotated upward to remove the front end of the ligulate strips S from the through-holes 121a before removing the ligulate strips S caught in the reception holes 120a, and it becomes possible to prevent damage to the bound paper sheets.

Moreover, in the paper binder 100 according to the present embodiment, the punch blades 123c that form the ligulate strips S by performing hole-punching, the incising blades 124 that form the incisions C, and the projections 123e that press the ligulate strips S into the engaging holes 124c are all arranged on the side of the base 101. According to this type of configuration, it is sufficient to form at least the reception holes 120a that receive the blades, etc. of the ligulate-strip processing portions 123 and the incising blades 124 on the pressing portion 120 on the side of the handle 110. That is, the space used by the pressing portion 120 can be reduced. Through this space reduction, it is, for example, possible to reduce the distance between the pressure shaft 112 and the rotation shaft 111. As a result, the manual force applied on the handle 110 can be applied efficiently, and it becomes possible to reduce the hole-punching load.

Moreover, as a result of this space reduction, it is possible to arrange the rotation shaft 111 anterior to the pressing portion 120 and to lower the rotation shaft 111 based on the height of the upper surface of the pressing portion 120. By lowering the height of the rotation shaft 111, it becomes possible to suppress the height of the supporting plate 103. As a result, it becomes possible to suppress increases in the overall size of the paper binder 100. Furthermore, when making the paper binder 100 a handheld tool, because it is possible to reduce the distance between the protruding end 110a of the handle 110 and the posterior edge of the posterior base 101a, it becomes possible to improve the operability of paper-binding operations.

Moreover, in the paper binder 100 according to the present embodiment, because the blade parts (123c, etc.) of the ligulate-strip processing portions 123 and the incising blades 124 are facing upward, after the completion of the process of binding the paper sheets, it is necessary to return these members to their original positions. In relation to this point, in the paper binder 100 according to the present embodiment, after the third elastic members 126 have been transformed due to the rotation of the ligulate-strip processing portions 123, when the raised portions 121f release the hook portions 123g as a result of the return of the handle 110, the third elastic members 126 attempt to return to their pre-rotational state using their own elasticity. Using this biasing force, even if the ligulate-strip processing portions 123 are rotated once, it becomes possible to return them to their original positions.

Next, technical concepts that can be understood from the above embodiment are described below.

(I) The paper binder according to claim 1, wherein

the punch blades and the projections are formed in an integrated manner,

when the mounting base and the base come near to each other in accordance with the rotation of the handle, holes are punched in the paper sheets arranged on the mounting base by the punch blades erected from the base to form the strips, and the incisions are formed between the punched holes by the incising blades, and

after the strips and the incisions have been formed, when the holding portion is pushed down further, the front end of the projections rotated toward the side of the incisions and fold over the strips in the direction of the incisions.

(II) The paper binder according to claim 1, wherein

the mounting base is provided with a raised portion erected in the direction of the base,

the projections are rotatably supported by the base, and

after the strips and the incisions have been formed, when the mounting base is brought even closer to the base, the raised portion presses for part of the projections, the front end of the projections rotates toward the side of the incisions, and the strips are folded over in the direction of the incisions.

(III) The paper binder according to claim 2, wherein

the brace member is a tubular member and is provided on the base, the penetration portion is provided on the mounting base, the pressing portion penetrates the penetration portion and the inside of the brace member, and the brace member guides movement of the pressing portion and the mounting base in the base direction.

(IV) The paper binder according to claim 1, wherein

on the mounting base, on the side on which the paper sheets are inserted and on the both sides of the mounting base, a pair of gauge bases is provided, and

the gauge bases guide the corner part of the paper sheets so that they are held in place at the portion of the placement region where the punch blades pass through.

(V) The paper binder according to (IV) described above, wherein

the respective heights of the gauge bases are formed to be lower than the height from the base to the basal surface part, and

when the paper sheets are passed through between the gauge bases, the corner part of the paper sheets is guided to be held in place at the pass-through portion, and when the paper sheets are passed through to be placed on the gauge bases and inserted into the placement region, the paper sheets are not guided.

(VI) The paper binder according to claim 2, wherein

the pressing portion is linked to the handle by being interiorly penetrated by the pressure shaft on the surface on the side of the handle, and

the pressure shaft is able to slide inside the link part.

(VII) The paper binder according to claim 1, wherein the projections are provided with a biasing means that provides a bias in the direction opposite to the direction of rotation of the projections corresponding to the rotation of the handle.

(VIII) A paper binder that, by punching holes in a plurality of layered paper sheets, forms roughly ligulate strips that are partially connected to the paper sheets while also forming incisions near the strips, and also presses the strips into the incisions to bind the plurality of paper sheets, comprising:

a base;

a first handle extending rearward from the base;

a pair of punch blades that are erected upward from the base and formed with blade parts on the upper edges;

a pair of incising blades that are erected upward from the base and formed with blade parts on the upper edges;

a supporting part erected upward from the base;

a second handle that is connected on approximately the upper edge of the supporting part via a rotation shaft, that extends rearward, and on which a window portion is formed at the position above the pair of punch blades and the pair of incising blades as well as the surrounding positions;

a mounting base that is provided between the base and second handle in a manner enabling upward and downward movement relative to the base, that is formed with through-holes on the upper surface at the respective positions above the pair of the punch blades and the pair of incising blades, and on which the plurality of paper sheets are mounted on the upper surface;

a pressing portion that has a lower surface arranged facing the upper surface of the mounting base, that is formed with through-holes on the upper surface at the respective positions above the pair of punch blades and the pair of incising blades, that is formed with a window portion at the same positions and their surrounding positions, and that is provided in a manner enabling upward and downward movement relative to the mounting base, and

an insertion mechanism for inserting the strips into the incisions, wherein

as a result of the pressing portion and the mounting base being brought close together due to the rotation of the handle, the paper sheets on the mounting base are pinched, and as a result of the pressing portion and the mounting base being moved toward the base while pinching the paper sheets, the paper sheets are pressed against the edge parts of the punch blades and the incising blades to form the strips and the incisions.

The “first handle” and “second handle” in the technical concept (VIII) described above are both defined as handles based on the assumption that the operator will use the paper binder with their hands.

What is claimed is:

1. A paper binder configure to punch a hole in a plurality of layered paper sheets to cut off part of the paper sheets and form ligulate strips and form incisions near the strips and insert the strips into the incisions to bind the paper sheets, comprising:
a base;
a support base erected on the base;
a handle that is connected to the support base via a rotation shaft and that is rotatable about the rotation shaft;
a pair of punch blades that protrude from the base toward the handle and punch holes;
a pair of incising blades that protrude from the base toward the handle and form the incision;
a pair of projections that are rotated together with the rotation of the handle and press against the formed strips to fold the strips toward the paper sheets;
a mounting base that is arranged between the base and the handle, provided with through-holes through which the edge parts toward the projection direction of the projections, the punch blades, and the incising blades are able to pass, on which the paper sheets are mounted;
a pressing portion that is arranged at a position enclosed by the handle and the mounting base, that is capable of receiving each of the edge parts passing through the through-holes, that includes reception holes in the interior in which the projections are able to rotate, that is configured so that the vicinity of the through-holes of the mounting base are visible from the side of the handle through at least the reception holes and their surroundings, and that pinches the paper sheets together with the mounting base;
a window portion provided on the handle at a part including a region overlapping with at least the reception holes of the pressing portion; and
a movement mechanism that brings closely the relative positions of the pressing portion and the mounting base depending on the handle rotates, and moves the mounting base toward the base together with the pressing portion, wherein
as a result of the pressing portion and the mounting base being brought closely by the movement mechanism, the paper sheets on the mounting base are pinched, and by moving the pressing portion and the mounting base toward the base while pinching the paper sheets, the edge parts of the punch blades and the incising blades are pressed against the paper sheets to form the strips and the incision.

2. The paper binder according to claim 1, further comprising:
a pressure shaft that is provided between the front end of the projection direction of the handle and the rotation shaft alongside the rotation shaft and abuts the pressing portion, wherein
the movement mechanism includes: a brace member that is provided on one of the facing surfaces of the base and the mounting base and protrudes in the direction of movement of the mounting base; a penetration portion that is provided on the other facing surface and is penetrated by the brace member; and a biasing portion that is provided between the base and the mounting base and separates the base and the mounting base, and
the pressure shaft is positioned relative to the biasing portion on approximately an extension in the bias direction of the biasing portion, and presses down the pressing portion toward the base as the handle rotates.

3. The paper binder according to claim 1, wherein
the support base includes a pair of supporting plates erected on both sides of the base, and the supporting plates include a bearing that supports edge parts in the axis direction of the rotation shaft, and
the handle is arranged at a position enclosed by the pair of supporting plates, and is supported by the supporting plates via axis holes that allow the rotation shaft to penetrate at positions corresponding to the bearing.

4. A paper binder comprising:
a punch blade that forms partially connected strips by punching a hole into paper sheets;
an incising blade that forms incisions into which the strips can be inserted;
a base that supports both the punch blade and the incising blade so as to cause them to protrude upward, and that also supports the punch blade in a rotatable manner;
a mounting base including: a mounting surface that is arranged above the base and is approximately perpendicular to the punch blade and the incising blade; and through-holes provided on the mounting surface through which the front ends of the punch blade and the incising blade are able to pass;
a rotation mechanism that is provided on the mounting surface on the side of the base, and that abuts the punch blade as the mounting surface and the base of the punch blade are brought closely and causes the punch blade to rotate;
an insertion part that is provided on the punch blade and presses the strips into the incisions when the punch blade rotates;
a pressing table that includes: a pressing surface provided above the mounting surface at a position approximately facing the mounting surface; and reception holes that are provided on the pressing surface on extensions of the projection directions of the punch blade and the incising blade at positions corresponding to the through-holes, and that receive the front ends of the punch blade and the incising blade that pass through the through-holes, that is formed so that paper sheets on the mounting surface are visible from above in at least one region including the reception holes, and that is able to move toward the mounting surface;
a support base that extends from the base to a position higher than at least the mounting surface; and
a handle that is rotatably supported by the support base, that is arranged so as to enclose the pressing table and the mounting base together with the base, and that is provided with a window portion that makes at least part of the pressing table including the reception holes visible from above, wherein
as a result of the lowering of the pressing table as the handle rotates, the pressing table and the mounting base pinch the paper sheets, and as a result of the lowering of the pressing table and the mounting base associated with additional rotation of the handle, the punch blade and the incising blade form the strips and the incisions in the pinched paper sheets.
